(19) United States
(12) Patent Application Publication
(10) Pub. No.: US 2003/0220879 A1
(43) Pub. Date: Nov. 27, 2003

(54) System and method for electronic document processing

(76) Inventors: Breen P. Gaughan, San Diego, CA (US); William T. Finger, San Diego, CA (US)

Correspondence Address: CHRISTIE, PARKER & HALE, LLP, P.O. BOX 7068, PASADENA, CA, 91109-7068, US

(21) Appl. No.: 10/242,190

(22) Filed: Sep. 11, 2002

Related U.S. Application Data
(60) Provisional application No. 60/332,163, filed on Nov. 21, 2001.

(51) Int. Cl. G06F 17/60

(52) U.S. Cl. 705/51

(57) ABSTRACT

A system and method for providing electronic document processing via a network such as the Internet. A superuser defines access rules by which other users can access the system. Electronic documents are generated, processed, and reviewed by different users fulfilling different roles within a loan documentation process. An originator initiates electronic document processing by transmitting electronic documents to a document server. An electronic document processor evaluates the electronic documents and determines their applicability to defined documentation processes. An electronic document manager defines the documentation processes and balances processing activities for a plurality of electronic document processors. Ultimately, the electronic documents are made available to a plurality of electronic document recipients in specific formats specifiable by each of the electronic document recipients.

### CROSS REFERENCE TO RELATED APPLICATIONS

This application claims the benefit of U.S. Provisional Patent Application No. 60/332,163, filed Nov. 21, 2001, which is incorporated by reference herein.

### BACKGROUND OF THE INVENTION

The present invention generally relates to the field of electronic document processing and more specifically to electronic (paperless) processing of loan applications.

A number of techniques have evolved in recent years as network technology, including Intranets and particularly the Internet, has grown in size and sophistication, including:

The use of Web servers and hypertext markup language (HTML) delivery to Web browsers.

The use of the application-server model for connecting database information with Web pages and interactive interfaces for end users.

The use of dynamically generated HTML that pulls information from a database to dynamically format HTML for delivery to the end user.

The use of a template language to merge database output with pre-formatted HTML presentations.

The use of ‘cookies’ to track individual user preferences as they interact with the Web pages and applications.

The use of messaging and chat technology.

The use of HTTP and FTP transfer protocols to upload video content to a Website.

The practice of sending electronic mail, commonly referred to as e-mail, as a way of communicating via a network.

These and other related Web technologies and techniques are in commonplace use and readily accessible on the Internet. The use of the Internet as an education, commerce and recreation tool has grown dramatically in recent years. Some estimates place the number of Web pages on the Internet at as high as 800 million. Most websites provide text and image data, while some also provide streaming image data. Still other websites allow a user to interact with the host server to conduct transactions.

Internet programs and websites currently exist providing a large number of features and services, including the automation of previously manual processes. However, there is a need to provide a system and method for providing automation of the entire mortgage loan process, thereby greatly expediting the process, increasing consumer satisfaction, and increasing profit margins to the mortgage lender institutions.

### SUMMARY OF THE INVENTION

A system and method is provided for electronic document processing via a network such as the Internet. In one aspect of the invention, a superuser defines access rules by which other users can access the system. Electronic documents are generated, processed, and reviewed by different users fulfilling different roles within a loan documentation process. An originator initiates electronic document processing by transmitting electronic documents to a document server. An electronic document processor evaluates the electronic documents stored on the electronic document server and determines their applicability to defined documentation processes. An electronic document manager defines the documentation processes and balances processing activities for a plurality of electronic document processors. Ultimately, the electronic documents are made available to a plurality of electronic document recipients in formats specifiable by each of the electronic document recipients.

In another aspect of the invention, a system for processing electronic documents includes an electronic document server having electronic document originator and recipient access rules. The system further includes an originator interface for receiving electronic documents by the electronic document server from an originator. The originator interface implements the electronic originator access rules ensuring the originator properly transmits the electronic documents. The system further includes a recipient interface for transmitting electronic documents by the electronic document server to a recipient. The recipient interface ensures that the electronic documents are transmitted to the recipient in accordance with the electronic document recipient access rules.

In another aspect of the invention, the document originator access rules prevent the originator from modifying the electronic documents received by the document server from the originator. In addition, the originator access rules prevent the originator from viewing a second electronic document received by the document server from a second originator. Even though one originator may not view the documents supplied by another originator, the recipient access rules allow a recipient to view electronic documents submitted by a plurality of originators.

In another aspect of the invention, the document server further includes electronic document processor access rules. An electronic document process uses a processor interface for processing the electronic documents in accordance with the electronic document processor access rules. In addition, the document server includes electronic document manager access rules and has a manager interface for managing the electronic documents by a manager in accordance with the electronic document manager access rules.

In another aspect of the invention, the document server further includes an expandable electronic file for storage of the electronic documents. In this embodiment of the invention, the electronic document recipient access rules include a stacking order for organizing electronic documents stored in the expandable electronic file and transmitted to the recipient.

In another aspect of the invention, a scanner is included for generating scanned electronic documents, wherein the scanned electronic documents are transmitted to the electronic document server via the originator interface. The originator interface is further enhanced with an interface for identifying a name and a document type for the scanned document.

In another aspect of the invention, the system further includes a superuser interface for defining the electronic document originator access rules and the electronic document recipient access rules.

In another aspect of the invention, a system for processing electronic loan documents is provided. The system includes a loan document server including a plurality of electronic loan documents for a plurality of electronic loan applications and a database of information describing the electronic loan documents for each of the electronic loan applications. The database defines a stacking order for the electronic loan documents for each of a plurality of lenders. The system further includes a lender interface for viewing the electronic documents. The electronic document are arranged and displayed in the stacking order that is defined by the database of information.

In another aspect of the invention, each document of a selected type is sequenced in the stacking order contiguously with other documents of the same type.

In another aspect of the invention, a system is provided for processing electronic documents having a document server including: a plurality of electronic documents; a database of information describing the electronic documents; and an administrative interface for identifying the name of the electronic documents. The name of a selected electronic document is definable on a lender by lender basis and stored in the database of information. A plurality of lenders use a lender interface to view the electronic documents. For each lender, the names of the electronic documents are named in accordance with identity of the lender and the defined name information that is stored in the database of information.

In another aspect of the invention, a method for processing electronic loan documents is provided. An electronic document server includes electronic loan document manager access rules, electronic loan document processor access rules, electronic loan document originator access rules, and electronic loan document recipient access rules. The electronic document server further includes an originator interface, a processor interface, and a recipient interface. The electronic document server receives an electronic loan document from an originator using the originator interface in accordance with the electronic loan document originator access rules. The electronic loan documents are processed by a processor using the process interface in accordance with the electronic loan document processor access rules. The processed electronic loan documents are then transmitted to a lender by the electronic document server using the recipient interface in accordance with the electronic loan document recipient access rules.

In another aspect of the invention, the system is further provided with a manager interface. A manager managers the processing of the electronic loan documents using the manager interface in accordance with the electronic loan document manager access rules.

In another aspect of the invention, the system is provided with a superuser interface. A superuser defines the electronic loan document originator access rules, the electronic loan document processor access rules, the electronic loan document manager access rules, and the electronic loan document recipient access rules using the superuser interface.

### BRIEF DESCRIPTION OF THE DRAWINGS

These and other features, aspects, and advantages of the present invention will become better understood with regard to the following description and accompanying drawings where:

FIG. 1 is a diagram of one example of a network configuration in which an embodiment of this invention may operate;

FIG. 2 is a diagram depicting an electronic document processing system in accordance with an exemplary embodiment of the present invention;

FIG. 3 is a flowchart of access operations available to users of the electronic document processing system of FIG. 2;

FIG. 4 is a diagram of operations available to an originator of the electronic document processing system embodiment of FIG. 2;

FIG. 5 is a diagram of operations available to a manager of the electronic document processing system embodiment of FIG. 2;

FIG. 6 is a diagram of operations that may be available to a superuser of the electronic document processing system embodiment of FIG. 2;

FIG. 7 is a diagram of operations that may be available to a processor of an electronic document processing system embodiment such as shown in FIG. 2;

FIG. 8 is a diagram of operations that may be available to a third party of an electronic document processing system embodiment such as shown in FIG. 2;

FIG. 9 is a diagram of one embodiment of primary interface screen displays of the electronic document processing system shown in FIG. 2;

FIG. 10 is a diagram of one embodiment of administration interface screen displays of the electronic document processing system shown in FIG. 2;

FIG. 11 is a diagram of a loan account list screen display as shown in the primary interface diagram of FIG. 9;

FIG. 12 is a diagram of a new loan account screen display as shown in the primary interface diagram of FIG. 9;

FIG. 13 is a diagram of a subject property photo addendum of an appraisal document of an electronic document processing system such as shown in FIG. 2;

FIG. 14 is a diagram of a standard loan application document screen display of an electronic document processing system such as shown in FIG. 2;

FIG. 15 is a diagram of a loan account detail screen display with a file upload feature as shown in the primary interface diagram of FIG. 9;

FIG. 16 is a diagram of a user profile screen display as shown in the primary interface diagram of FIG. 9;

FIG. 17 is a diagram of a loan account detail screen display as shown in the primary interface diagram of FIG. 9;

FIG. 18 is a diagram of a document detail screen display with original file format view feature as shown in the primary interface diagram of FIG. 9;

FIG. 19 is a diagram of a document detail screen display as shown in the primary interface diagram of FIG. 9;

FIG. 20 is a diagram of a master document list screen display as shown in the administration interface diagram of FIG. 10;

FIG. 21 is a diagram of a borrower list screen display as shown in the administration interface diagram of FIG. 10;

FIG. 22 is a diagram of a lender list screen display as shown in the administration interface diagram of FIG. 10;

FIG. 23 is a diagram of a stacking order selection screen display as shown in the administration interface diagram of FIG. 10;

FIG. 24 is a diagram of an assign processors screen display as shown in the primary interface diagram of FIG. 9;

FIG. 25 is a diagram of a user list screen display as shown in the administration interface diagram of FIG. 10;

FIG. 26 is a diagram of an assign lenders screen display as shown in the primary interface diagram of FIG. 9;

FIG. 27 is a diagram of a view loan application screen display as shown in the primary interface diagram of FIG. 9;

FIG. 28 is a diagram of an activity detail screen display as shown in the administration interface diagram of FIG. 10;

FIG. 29 is a diagram of an activity logs screen display as shown in the administration interface diagram of FIG. 10;

FIG. 30 is a diagram of a loan document access screen display as shown in the administration interface diagram of FIG. 10;

FIG. 31 is a diagram of an edit loan document access screen display as shown in the administration interface diagram of FIG. 10;

FIG. 32 is a diagram of a point program view screen display of the electronic document processing system of FIG. 2;

FIG. 33 is a diagram of a view loan application screen display of the electronic document processing system of FIG. 2;

FIG. 34 is a diagram of a loan account list screen display as shown in the primary interface diagram of FIG. 9;

FIG. 35 is a diagram of an embodiment of a business flow of the electronic document processing system of FIG. 2;

FIG. 36 is a diagram of an embodiment of a table of user access settings of the electronic document processing system of FIG. 2;

FIG. 37 is a block diagram illustrating the data tables that are maintained by the database in the document server (see FIG. 2) in one embodiment of the invention; and

FIG. 38 is a block diagram of an architecture of an electronic document processing system in accordance with an exemplary embodiment of the present invention.

### DETAILED DESCRIPTION

The following provides a number of useful possible definitions of terms used in describing embodiments of the disclosed invention.

A network may refer to a network or combination of networks spanning any geographical area, such as a local area network, wide area network, regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

A website may refer to one or more interrelated web page files and other files and programs on one or more web servers. The files and programs are accessible over a computer network, such as the Internet, by sending a hypertext transfer protocol (HTTP) request specifying a uniform resource locator (URL) that identifies the location of one of said web page files, wherein the files and programs are owned, managed or authorized by a single business entity. Such files and programs can include, for example, hypertext markup language (HTML) files, common gateway interface (CGI) files, and Java applications. The web page files preferably include a home page file that corresponds to a home page of the website. The home page can serve as a gateway or access point to the remaining files and programs contained within the website. In one embodiment, all of the files and programs are located under, and accessible within, the same network domain as the home page file. Alternatively, the files and programs can be located and accessible through several different network domains.

A web page or electronic page may comprise that which is presented by a standard web browser in response to an HTTP request specifying the URL by which the web page file is identified. A web page can include, for example, text, images, sound, video, and animation.

A computer or computing device may be any processor controlled device that permits access to the Internet, including terminal devices, such as personal computers, workstations, servers, clients, mini-computers, main-frame computers, laptop computers, a network of individual computers, mobile computers, palm-top computers, hand-held computers, set top boxes for a television, other types of web-enabled televisions, interactive kiosks, personal digital assistants, interactive or web-enabled wireless communications devices, mobile web browsers, or a combination thereof. The computers may further possess one or more input devices such as a keyboard, mouse, touch pad, joystick, pen-input-pad, and the like. The computers may also possess an output device, such as a visual display and an audio output. One or more of these computing devices may form a computing environment.

These computers may be uni-processor or multi-processor machines. Additionally, these computers may include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, digital cameras, compact disks, video tapes, audio tapes, magnetic recording tracks, electronic networks, and other techniques to transmit or store electronic content such as, by way of example, programs and data. In one embodiment, the computers are equipped with a network communication device such as a network interface card, a modem, or other network connection device suitable for connecting to the communication network. Furthermore, the computers execute an appropriate operating system such as Linux, Unix, any of the versions of Microsoft Windows, Apple MacOS, IBM OS/2 or other operating system. The appropriate operating system may include a communications protocol implementation that handles all incoming and outgoing message traffic passed over the Internet. In other embodiments, while the operating system may differ depending on the type of computer, the operating system will continue to provide the appropriate communications protocols to establish communication links with the Internet.

The computers may contain program logic, or other substrate configuration representing data and instructions, which cause the computer to operate in a specific and predefined manner, as described herein. In one embodiment, the program logic may be implemented as one or more object frameworks or modules. These modules may be configured to reside on the addressable storage medium and configured to execute on one or more processors. The modules include, but are not limited to, software or hardware components that perform certain tasks. Thus, a module may include, by way of example, components, such as, software components, object-oriented software components, class components and task components, processes, functions, attributes, procedures, subroutines, segments of program code, drivers, firmware, microcode, circuitry, data, databases, data structures, tables, arrays, and variables.

The various components of the system may communicate with each other and other components comprising the respective computers through mechanisms such as, by way of example, interprocess communication, remote procedure call, distributed object interfaces, and other various program interfaces. Furthermore, the functionality provided for in the components, modules, and databases may be combined into fewer components, modules, or databases or further separated into additional components, modules, or databases. Additionally, the components, modules, and databases may be implemented to execute on one or more computers. In another embodiment, some of the components, modules, and databases may be implemented to execute on one or more computers external to the website. In this instance, the website includes program logic, which enables the website to communicate with the externally implemented components, modules, and databases to perform the functions as disclosed herein.

An exemplary electronic document processing system in accordance with the present invention is a Web-based application utilizing the digital nature of the Internet in order to transform the loan application process into a paperless process. In the past, the loan application process was paper-intensive causing money to be spent on printing and postage of the loan document packages. With the conversion of the process into a digital form, both time and money can be saved by eliminating the need for paper documents. Additionally, the paper-intensive process required workers to constantly manipulate the paper documents, thus allowing the introduction of errors into the paper documents. Once the errors were introduced, it was very time consuming to find the errors and correct them. With the conversion of the process into a digital form errors can easily be found and corrected using automated validation processes.

Several user roles within the application manage loan documents through the loan application life cycle, from origination to lender assignment. Each user role has different responsibilities and control over a loan application through the process, shaping the application for each specific lender. When a loan application is assigned to a lender, the loan documents are presented to the lender in the lender's specific document stacking order, which is editable for each lender within the application. Workflow is managed by an email alert system, which sends out an email to the respective user when a loan application is assigned to them. The manager or superuser can restrict access to documents for specific users within a loan application. The Loan Document Management System will simplify and expedite the loan application process by storing the loan documents in a central location to be viewed and manipulated by all interested parties.

A loan application begins with an originator uploading the initial documents available for the loan. The loan processor is assigned to the loan application by the manager or superuser and takes ownership of the account. The loan processor gathers any other required documents and organizes the loan application for presentation to each assigned lender. The manager or superuser assigns the loan application to the applicable lenders once the application has been processed and approved. Once the loan application has been assigned to a lender, the lender will be allowed to view the loan application and its associated documents.

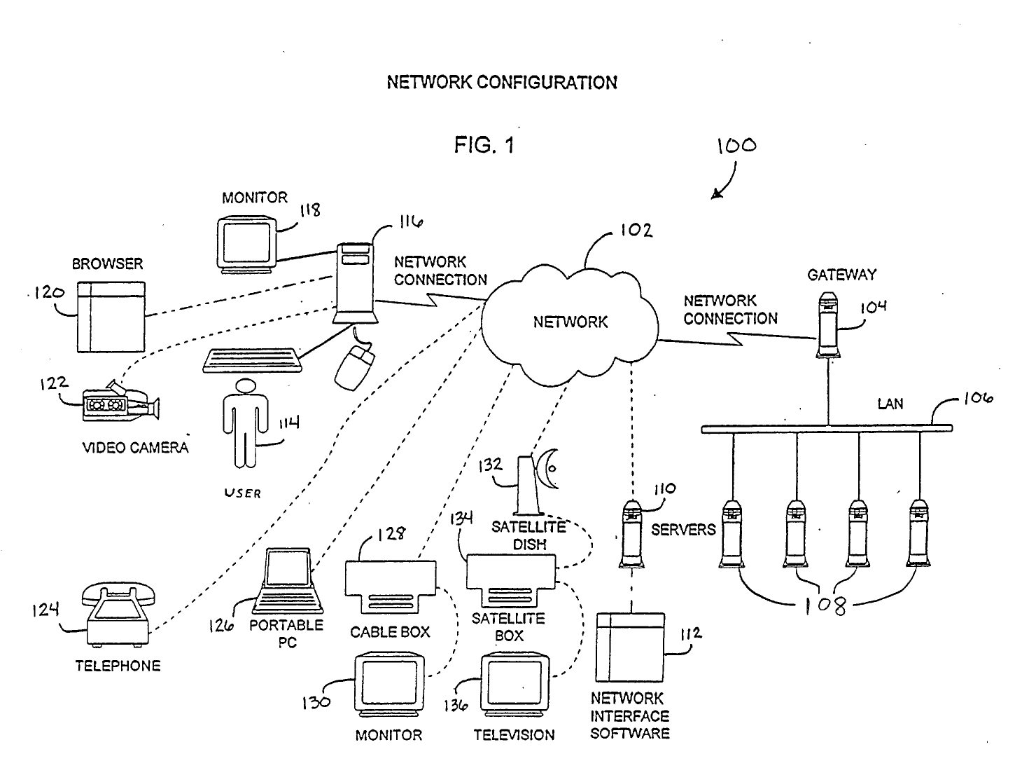

FIG. 1 is a diagram of one example of a network configuration 100 in which an embodiment of this invention may operate. However, various other types of electronic devices communicating in a networked environment may also be used. An end user 114 communicates with a computing environment, which may include multiple server computers 108 or a single server computer 110 in a client/server relationship on a network transmission medium 102. In a typical client/server environment, each of the server computers 108, 110 may include a server program that communicates with a user device 116, which may be a personal computer (PC), a hand-held electronic device (such as a PDA), a mobile or cellular wireless phone, a TV set, or any number of other electronic devices.

The server computers 108, 110, and the user device 116 may each have any conventional general purpose single- or multi-chip microprocessor, for example a Pentium processor, a Pentium Pro processor, a MIPS processor, a Power PC processor, an ALPHA processor, or other general purpose processors. In addition, the microprocessor may be any conventional special purpose microprocessor such as a digital signal processor or a graphics processor. Additionally, the server computers 108, 110 and the user device 116 may be desktop, server, portable, hand-held, set-top, or other desired type of computing device. Furthermore, the server computers 108, 110 and the user device 116 each may be used in connection with various operating systems, including, for example, UNIX, LINUX, Disk Operating System (DOS), VxWorks, PalmOS, OS/2, Mac OS, a version of Microsoft Windows, or other operating system.

The server computers 108, 110 and the user device 116 may each include a network terminal equipped with a video display, keyboard and pointing device. In one embodiment of the network configuration 100, the user device 116 includes a network browser 120 used to access the server computers 108, 110. The network browser 120 may be, for example, Microsoft Internet Explorer or Netscape Navigator. The user 114 at the user device 116 may utilize the browser 120 to remotely access the server program using a keyboard and/or pointing device and a visual display, such as a monitor 118. Although FIG. 1 shows only one user device 116, the network configuration 100 may include any number and type of user devices depending on the hardware infrastructure.

The network 102 may be any type of electronic transmission medium, for example, including but not limited to the following networks: a virtual private network, a public Internet, a private Internet, a secure Internet, a private network, a public network, a value-added network, an intranet, or a wireless gateway. In addition, the connectivity to the network 102 may be, for example, via a modem, Ethernet (IEEE 802.3), Token Ring (IEEE 802.5), Fiber Distributed Datalink Interface (FDDI), Asynchronous Transfer Mode (ATM), Wireless Application Protocol (WAP), or other form of network connectivity. The user device 116 may connect to the network 102 by use of a modem or by use of a network interface card that resides in the user device 116. The server computers 108 may be connected via a local area network 106 to a network gateway 104, which provides access to the local area network 106 via a high-speed, dedicated data circuit.

As would be understood by one skilled in the technology, devices other than the hardware configurations described above may be used to communicate with the server computers 108, 110. If the server computers 108, 110 are equipped with voice recognition or Dual Tone Multi-Frequency (DTMF) hardware, the user 114 may communicate with the server computers by use of a telephonic device 124. The telephonic device 124 may optionally be equipped with a display screen and a browser 120. Other examples of connection devices for communicating with the server computers 108, 110 include a portable personal computer (PC) 126 or a personal digital assistant (PDA) device with a modem or wireless connection interface, a cable interface device 128 connected to a visual display 130, or a satellite dish 132 connected to a satellite receiver 134 and a television 136. Still other methods of allowing communication between the user 114 and the server computers 108, 110 are additionally contemplated by this application.

Additionally, the server computers 108, 110 and the user device 116 may be located in different rooms, buildings or complexes. Moreover, the server computers 108, 110 and the user device 116 could be located in different geographical locations, for example in different cities, states or countries. This geographic flexibility which networked communications allows is within the contemplation of this application.

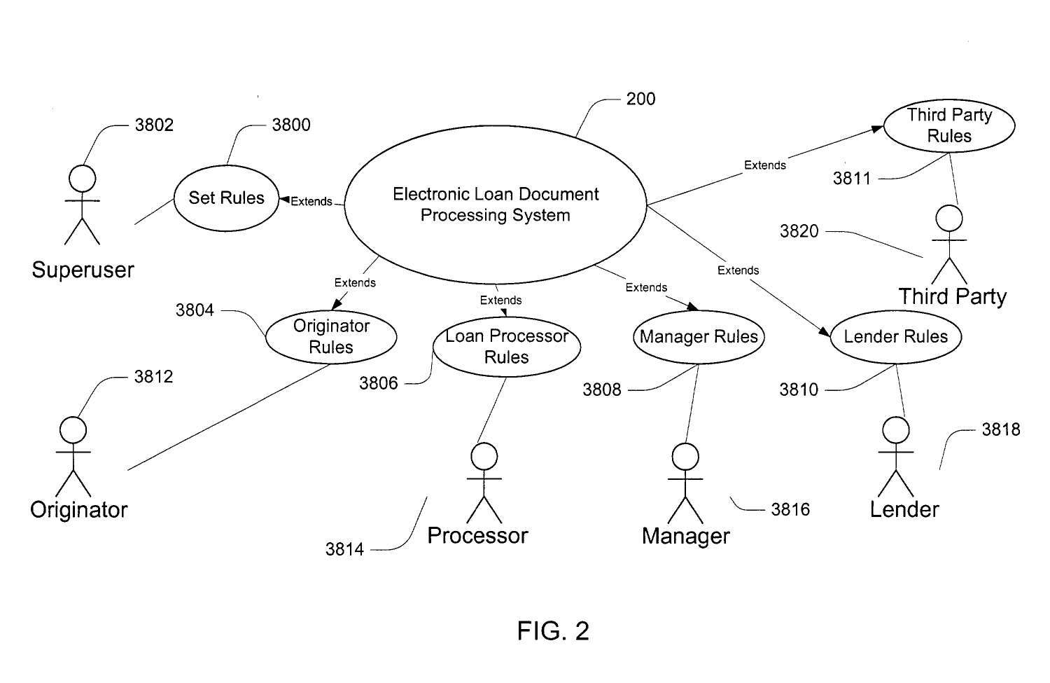

FIG. 2 is a diagram depicting an electronic document processing system in accordance with an exemplary embodiment of the present invention.

An electronic document processing system is extended in order for a superuser 3802 to set access rules 3800 by which the loan document processing system operates. A superuser has the ability to perform any task available to originators 3812, processors 3814, or managers 3816. The superuser is responsible for the overall management of the system. The superuser prevents bottlenecks within the loan application process by reassigning loan applications, or any other task that might help to speed the assignment of a loan application to a lender. Additionally, the superuser can add or remove users at any level.

The loan originator is responsible for originating a loan application and collecting required documents. The actions of the loan originator are mediated by originator access rules 3804 established by the superuser. The originator access rules extend the functionality of the electronic document processing system so that the loan originator can generate electronic documents. The loan originator meets with an applicant, gathers initial documents for the loan, converts the initial documents into electronic documents, and uploads the electronic documents to the electronic document processing system. Further manipulation of the electronic documents and associated documents is performed by the loan processor, the manager, and the superuser. The loan originator may not delete uploaded documents, but may add additional versions of each type of loan document. The originator may view a loan application, but is restricted to viewing only the electronic documents that were uploaded by the loan originator.

The loan processor is responsible for evaluating and managing the uploaded electronic documents for a loan application, requesting additional documents, and organizing the electronic documents for each specific lender. The electronic document processing system is extended by a set of loan processor access rules 3806 that are determined by the superuser. The loan processor may originate a loan application and has all the capabilities of an originator, but a processor's primary role is to process the loan application after the loan originator has uploaded the initial electronic documents. A loan processor manages the possible versions of each type of loan document and selects which version(s) to show to each specific lender. Unlike the originator, a loan processor views all documents within a loan application, and also has the ability to delete electronic documents. A loan processor has limited administrative capabilities within the application allowing for editing of a Master Document List, borrowers, lenders, and manipulation of each lender's stacking order of documents.

The manager's role within the loan document management system is to administer the inner-workings of the loan document management system and to supervise the loan application life cycle. A manager has the ability within the loan document management system to accomplish the tasks of an originator or processor, but has access to an administrative section of the website allowing for manipulation of the master document list, borrowers, lenders, stacking order, users, loan document access, and to view the activity logs for each loan application. The assignment of loan applications to originators, loan processors, and lenders is a function within the application accessible to the manager role. The role of the manager is mediated by a manager access rules 3808 extension to the electronic document processing system. The manager access rules are established by the superuser.

A loan document recipient, such as a lender 3818, is capable of viewing assigned loan applications. After the loan application and its associated documents have been approved by the manager or the superuser, the application is assigned to a lender. The lender views only the versions of the documents that are selected by the processor, manager, or superuser to be viewable by the lender. The lender cannot edit or manipulate the loan application except to add a lender-specific loan account number and lender specific electronic documents. The role of the lender is mediated by a lender access rules 3810 extension to the electronic document processing system. The lender access rules are established by the superuser.

A third party 3820 is capable of adding new electronic documents to be processed by other users of the electronic document processing system. An exemplary third party is an appraiser hired to appraise real estate for the purpose of obtaining a mortgage. A third party may enter reports, photographs, and other documents as additional electronic documents. The role of the third party is mediated by a third party access rules 3811 extension to the electronic document processing system. The third party access rules are established by the superuser.

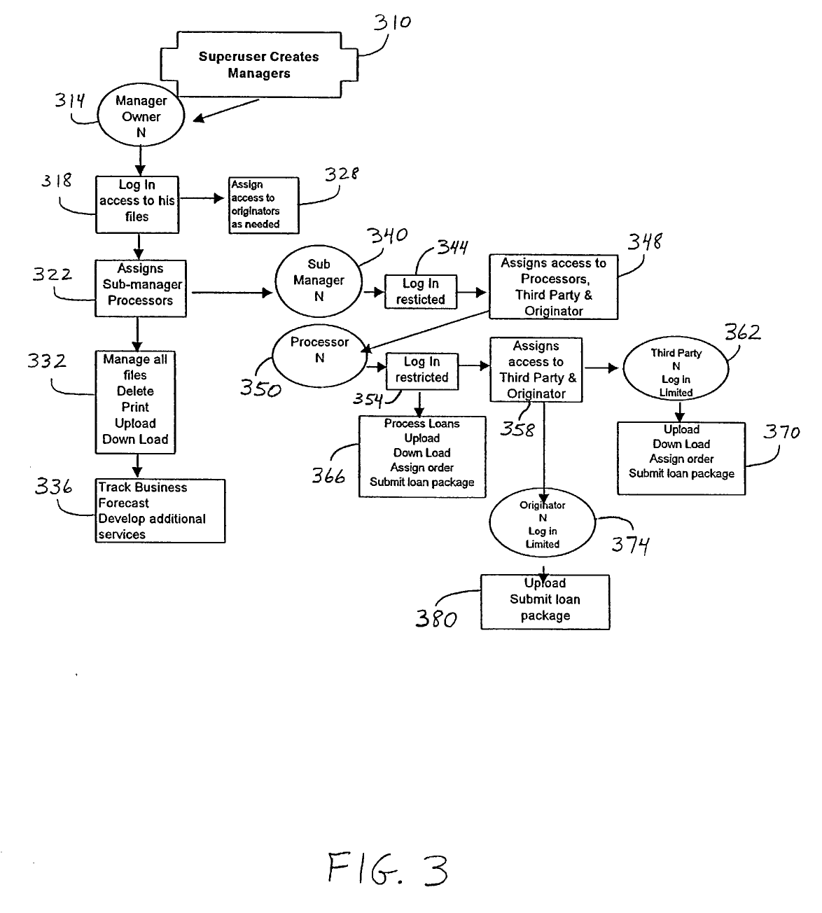

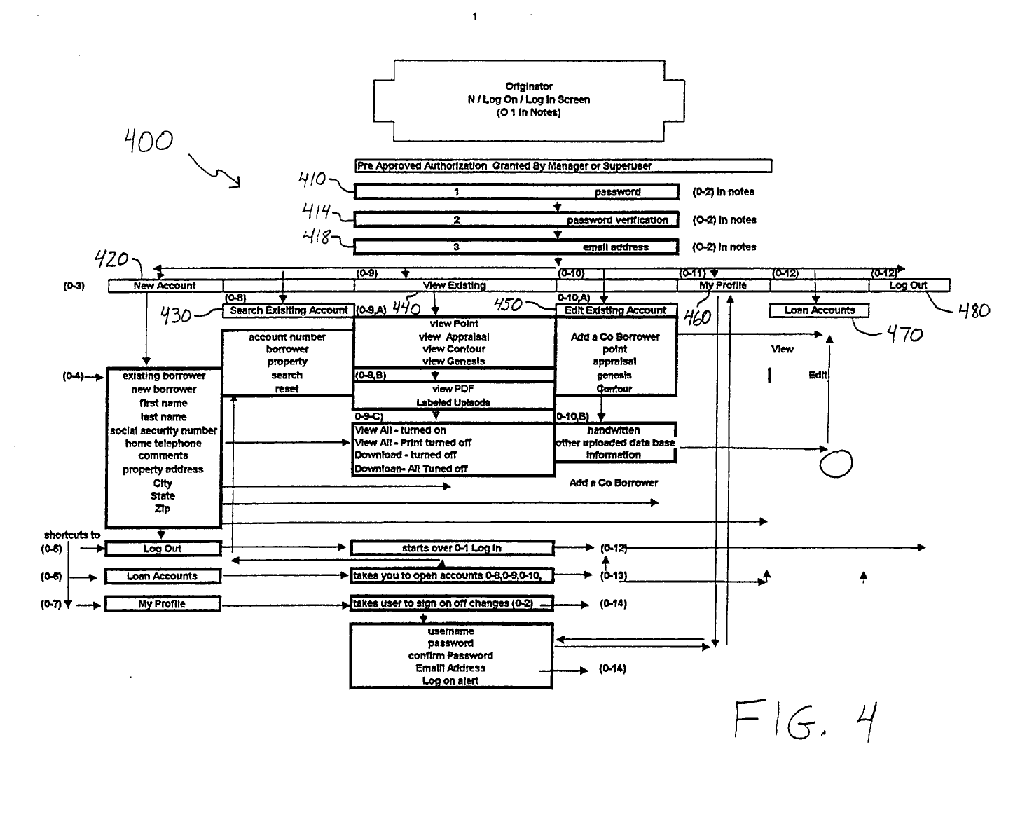

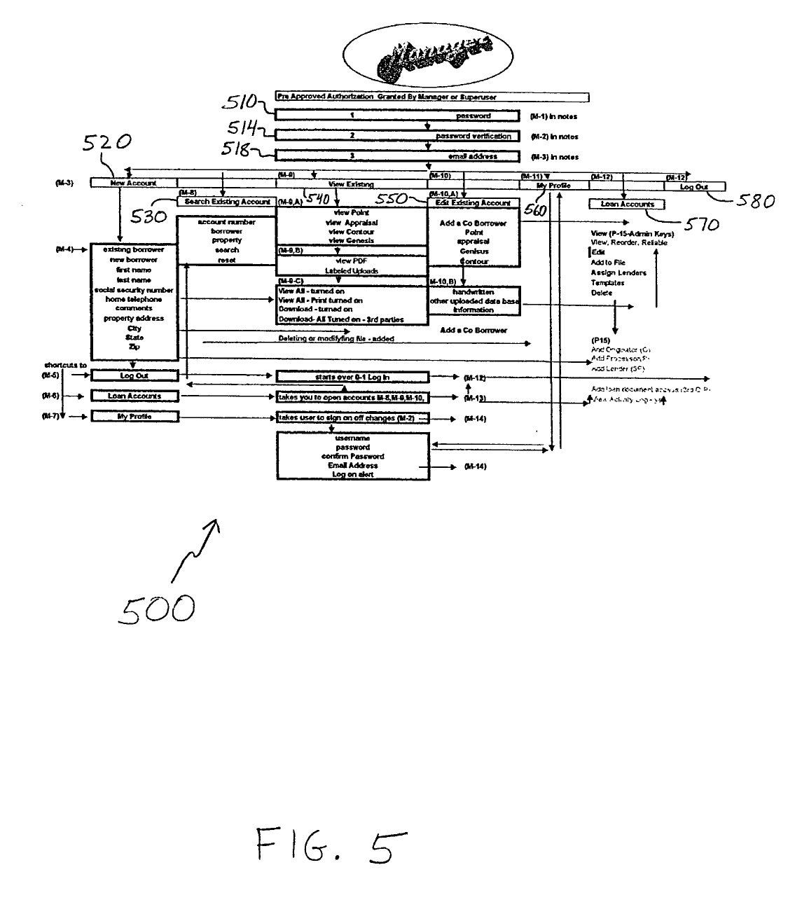

FIG. 3 is a flowchart of access operations that are available to users of the electronic document processing system 200 embodiment of FIG. 2. In this embodiment, at stage 310 a superuser may create a manager. The superuser tasks include creating managers. The manager capabilities are discussed below in relation to FIG. 5. State 314 shows a manager ‘N’ as created by the superuser at state 310 above. The ‘N’ at state 314 illustrates that one or more managers may exist contemporaneously. At state 318, the manager may log in to the system 200 and gain access to the manager's files. At state 322, the manager may assign sub-managers to one or more tasks, clients, accounts or applications. At state 328, the manager may additionally assign access to originators. The originator capabilities and operations are discussed below in relation to FIG. 4. At state 332, the manager may perform loan application management operations including electronic document deleting, printing, uploading, or downloading. At state 336, the manager may perform additional operations including tracking business forecasts or developing additional services.

In the embodiment of FIG. 3, state 340 illustrates the existence of one or more sub-managers in the system 200, who may be assigned one or more tasks by the manager as described above in relation to state 322. The ‘N’ at state 340 illustrates that one or more sub-managers may exist contemporaneously. At state 344, the sub-manager may log in to the to the system 200, and at state 348 perform operations including assigning access to processor, third parties, and originators. State 350 illustrates the existence of one or more processors in the system 200, who may be assigned one or more tasks by the sub-manager as described above in relation to state 348. The ‘N’ at state 350 illustrates that one or more processors may be created and exist contemporaneously. At state 354, the processor may log in to the to the system 200, and at state 358 perform operations including assigning access to third parties and originators. At state 366, the processor may perform additional loan processing operations including uploading files, downloading files, assigning orders of files, accounts, or applications, or submitting a package of related files or documents.

In the embodiment of FIG. 3, state 362 illustrates the existence of one or more third party in the system 200, who may be assigned one or more tasks by the processor as described above in relation to state 358. The ‘N’ at state 362 illustrates that one or more third parties may exist contemporaneously. At state 370, the third party may perform additional operations including uploading files, downloading files, assigning orders of files, accounts, or applications, or submitting a package of related electronic documents. State 374 illustrates the existence of one or more originators in the system 200, who may be assigned one or more tasks by the processor as described above in relation to state 358. The ‘N’ at state 374 illustrates that one or more originators may exist contemporaneously. At state 380, the originator may perform additional operations including uploading electronic documents.

FIG. 4 is a diagram of operations 400 that may be available to an originator. The various operations that an originator may perform include logging in to the system 200 by providing password 410, password verification 414 and email address 418 information, adding new accounts 420, searching existing accounts 430, view existing accounts 440, edit existing accounts 450, viewing and editing the particular user profile 460, managing existing accounts 470, or logging out 480 of the system 200. However, the operations that may be performed by originators is not limited to those illustrated in FIG. 4.

FIG. 5 is a diagram of operations 500 that may be available to a manager of the electronic document processing system 200 embodiment of FIG. 2. The various operations a manager may perform include logging in to the system 200 by providing password 510, password verification 514 and email address 518 information, adding new accounts 520, searching existing accounts 530, view existing accounts 540, edit existing accounts 550, viewing and editing the particular user profile 560, managing existing accounts 570, or logging out 580 of the system 200. However, the operations that may be performed by managers is not limited to those illustrated in FIG. 5.

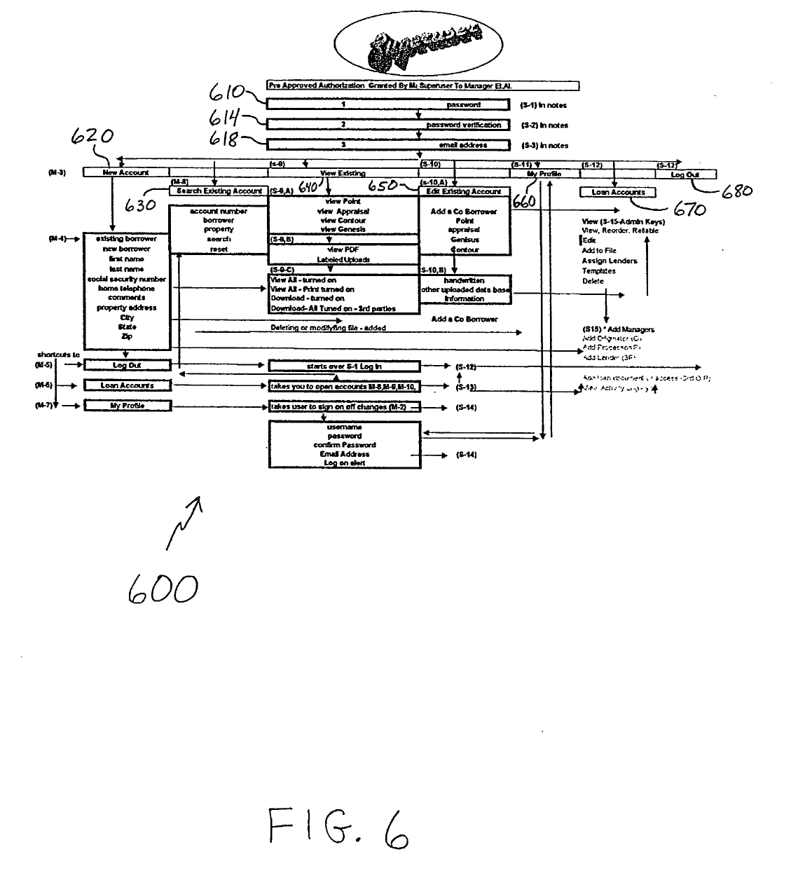

FIG. 6 is a diagram of operations 600 that may be available to a superuser of the electronic document processing system 200 embodiment of FIG. 2. The various operations a superuser may perform include logging in to the system 200 by providing password 610, password verification 614 and email address 618 information, adding new accounts 620, searching existing accounts 630, view existing accounts 640, edit existing accounts 650, viewing and editing the particular user profile 660, managing existing accounts 670, or logging out 680 of the system 200. However, the operations that may be performed by the superuser is not limited to those illustrated in FIG. 6.

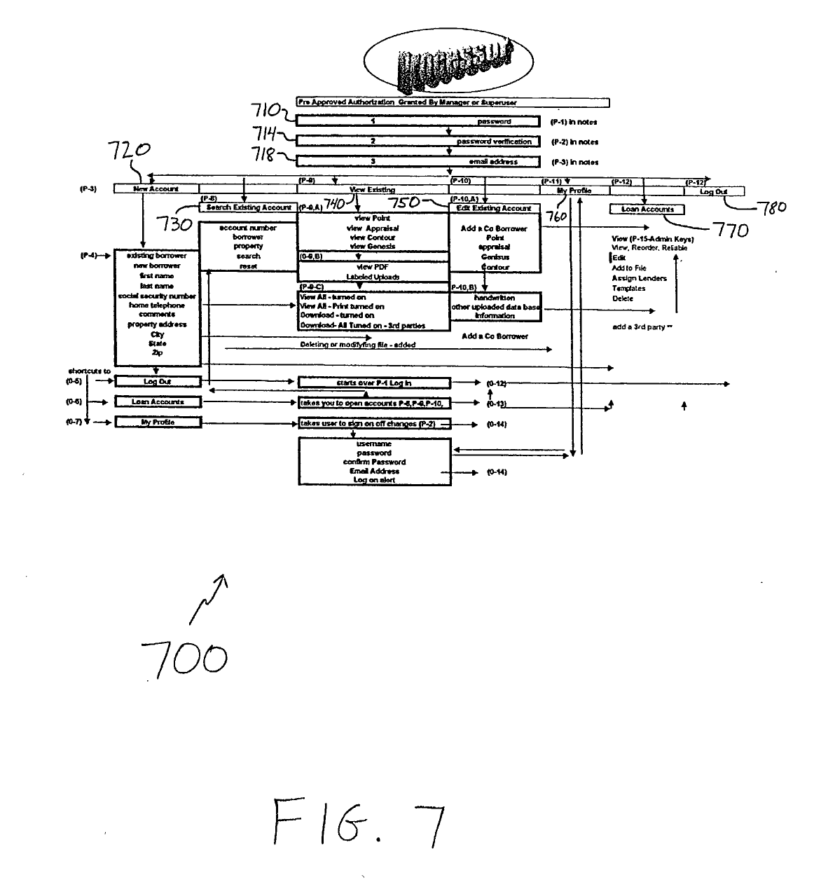

FIG. 7 is a diagram of operations 700 that may be available to a processor of the electronic document processing system 200 embodiment of FIG. 2. The various operations a superuser may perform include logging in to the system 200 by providing password 710, password verification 714 and email address 718 information, adding new accounts 720, searching existing accounts 730, view existing accounts 740, edit existing accounts 750, viewing and editing the particular user profile 760, managing existing accounts 770, or logging out 780 of the system 200. However, the operations that may be performed by the superuser is not limited to those illustrated in FIG. 7.

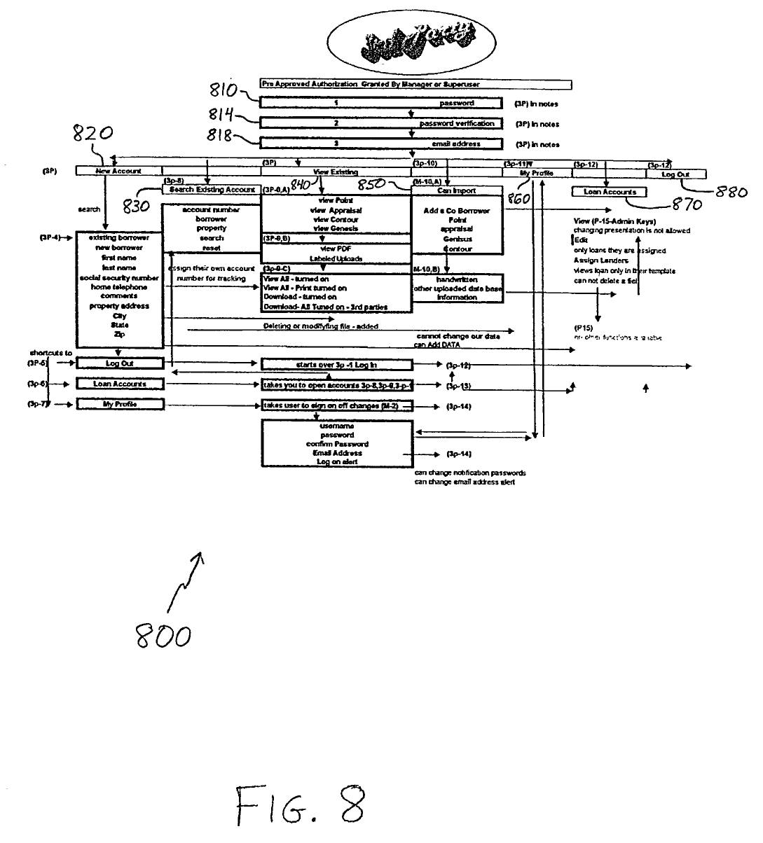

FIG. 8 is a diagram of operations 800 that may be available to a third party of the electronic document processing system 200 embodiment of FIG. 2. The various operations a third party may perform include logging in to the system 200 by providing password 810, password verification 814 and email address 818 information, adding new accounts 820, searching existing accounts 830, view existing accounts 840, edit existing accounts 850, viewing and editing the particular user profile 860, managing existing accounts 870, or logging out 880 of the system 200. However, the operations that may be performed by the third party is not limited to those illustrated in FIG. 8.

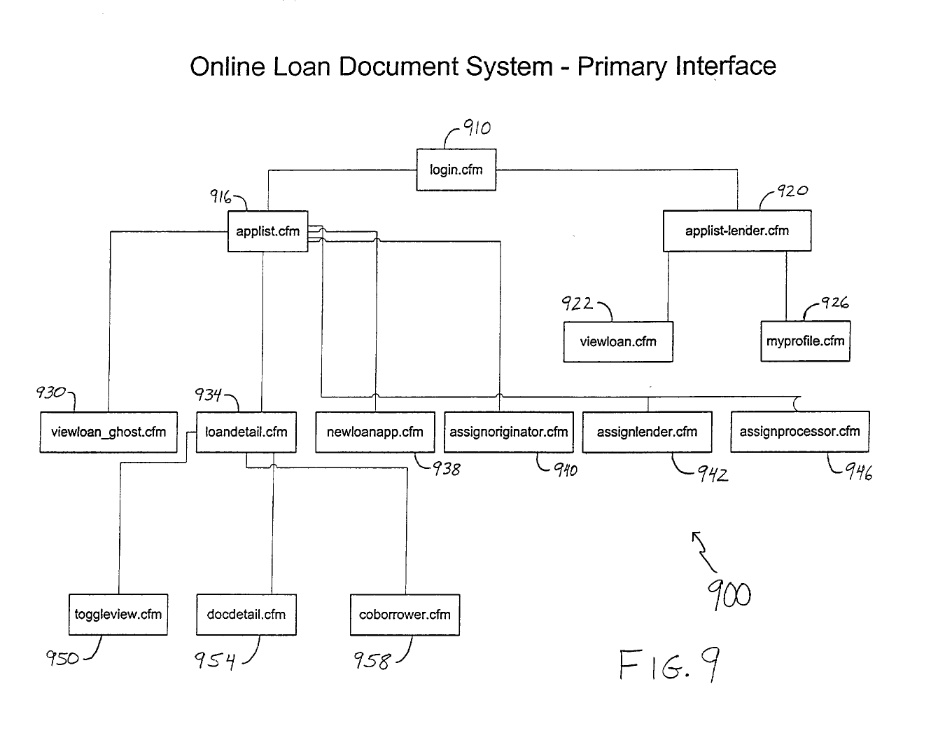

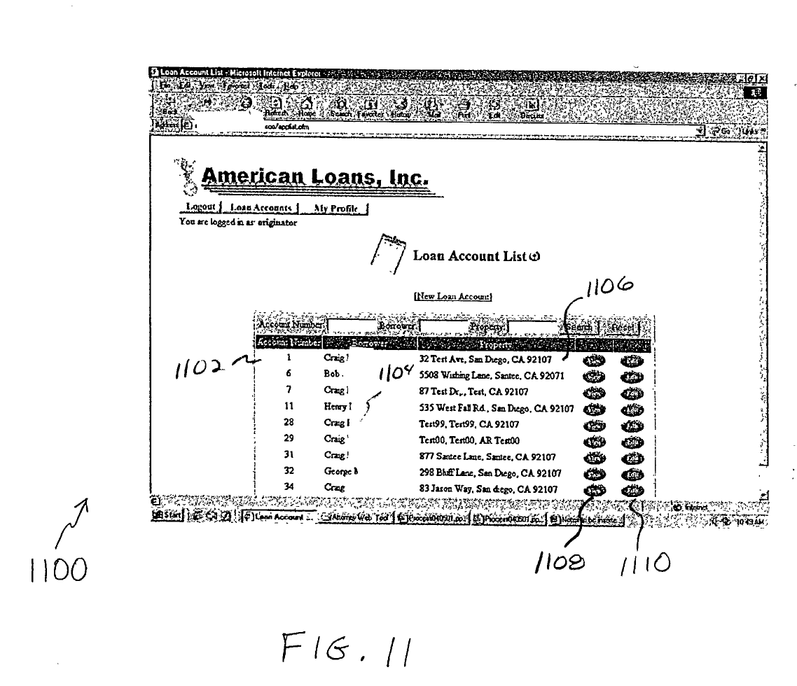

FIG. 9 is a diagram of one embodiment of primary interface screen displays 900 of the electronic document processing system 200 shown in FIG. 2. The embodiment illustrated in FIG. 9 electronically processes electronic documents, but one skilled in the technology would understand that other types of documents may also be processed in a similar fashion as described herein. The screen displays 900 include a login display 910, an application list display 916 (as shown in the embodiment of FIG. 11), another embodiment of an application list display for lending entities 920, a view loan display for lending entities 922, a view and edit user profile display for lending entities 926, another embodiment of a view loan display 930, a loan detail display 934, a new loan application display 938, an assign originator display 940, an assign lender display 942, an assign processor display 946, a toggle view display 950, a document detail display 954, or a coborrow display 958.

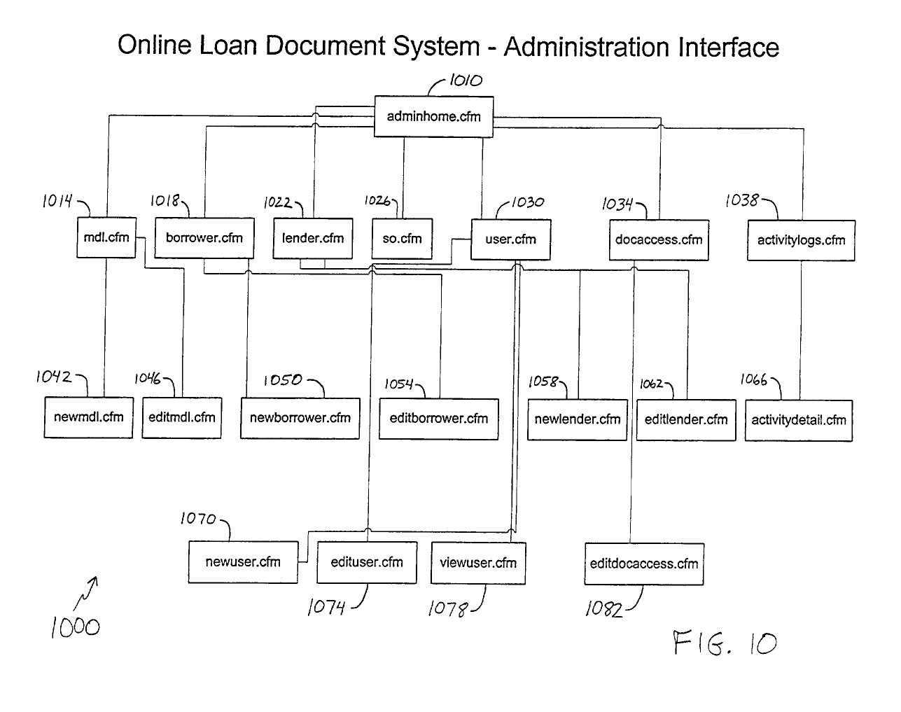

FIG. 10 is a diagram of one embodiment of administration interface screen displays 1000 of the electronic document processing system 200 shown in FIG. 2. The embodiment illustrated in FIG. 10 electronically processes electronic documents, but one skilled in the technology would understand that other types of documents may also be processed in a similar fashion as described herein. The screen displays 1000 include an administration home display 1010, a master document list display 1014, a borrower list display 1018, a lender list display 1022, a stacking order selection display 1026, a user list display 1030, a loan document access display 1034, an activity logs display 1038, a new master document list display 1042, or an edit master document list display 1046. Additional displays shown in the embodiment of FIG. 10 include a new borrower display 1050, an edit borrower display 1054, a new lender display 1062, an activity detail display 1066, a new user display 1070, an edit user display 1074, a view user display 1078, or an edit document access display 1082.

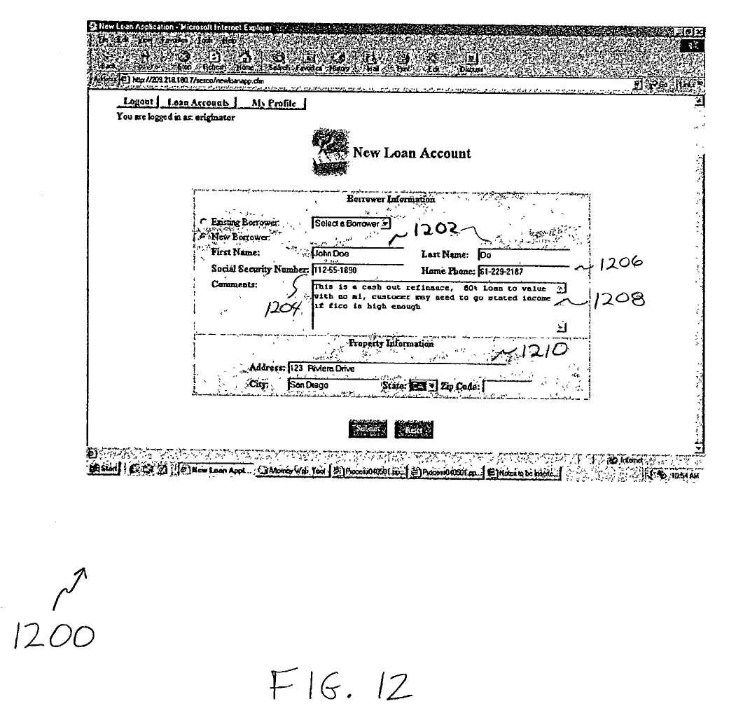

FIG. 11 is a diagram of a loan account list screen display 1100 as shown in the primary interface diagram 900 of FIG. 9. The loan account list display 1100 (applist.cfm 916 in FIG. 9) may include information relating to a list of available accounts to select for viewing 1108 or editing 1110, for example an account number 1102, a borrower name 1104, a property address 1106, or other loan account information. While the display 1100 shown in FIG. 11 is for an originator, corresponding displays for other users may also exist, which may be the same as shown in FIG. 11 or may be different. One of ordinary skill in the technology would understand that the display 1100 is shown for the purpose of example and could be configured in many ways that are also be within the scope of the invention herein. Similarly, the additional screen displays shown in the other figures of this application (FIGS. 12-34) are shown as examples and could be configured in many ways that are also within the scope of the invention.

FIG. 12 is a diagram of a new loan account screen display 1200 as shown in the primary interface diagram 900 of FIG. 9. The new loan account display 1200 (newloanapp.cfm 938 in FIG. 9) may include borrower information, for example name 1202, social security number 1204, phone number 1206, comments 1208, property information 1210, or other borrower information. While the display 1200 shown in FIG. 12 is for an originator, corresponding displays for other users may also exist, which may be the same as shown in FIG. 12 or may be different.

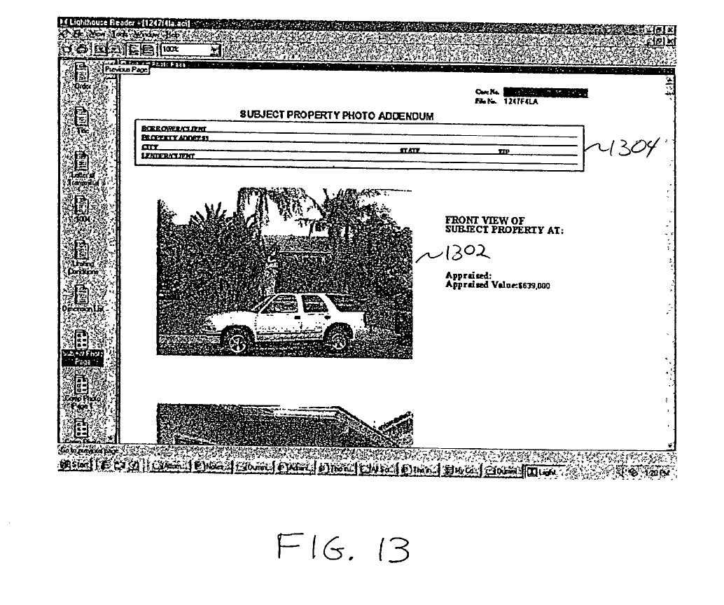

FIG. 13 is a diagram of a subject property photo addendum 1300 of an appraisal document of the electronic document processing system 200 shown in FIG. 2. The subject property photo addendum display 1300 may include one or more photographic images 1302 of a subject property, borrower information 1304, or other borrower information. The subject property photo addendum display 1300 may be created electronically, created in electronic form from a paper form by utilizing an optical scanner, or other ways of creating electronic documents. Other vendor documents may also be displayed similar to the subject property photo addendum display 1300 embodiment in FIG. 13, for example any number of the following: title document, complete appraisal document, escrow document, credit report, good faith document, HUD-1 document, or other examples of vendor documents.

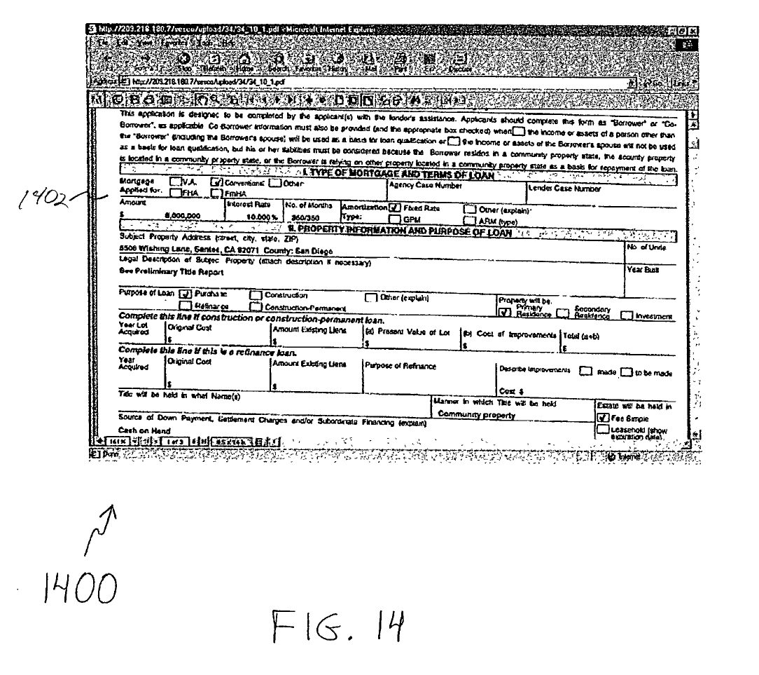

FIG. 14 is a diagram of a standard loan application document screen display 1400 of the electronic document processing system 200 shown in FIG. 2. The standard loan application document display 1400 may include one or more vendor document forms, as shown in FIG. 14 by the HUD-1 document. The vendor document may be created electronically, created in electronic form from a paper form by utilizing an optical scanner, or other ways of creating electronic documents. Other vendor documents may also be displayed similar to the standard loan application document display 1400 embodiment in FIG. 14, for example any number of the following: title document, complete appraisal document, escrow document, credit report, good faith document, or other examples of vendor documents.

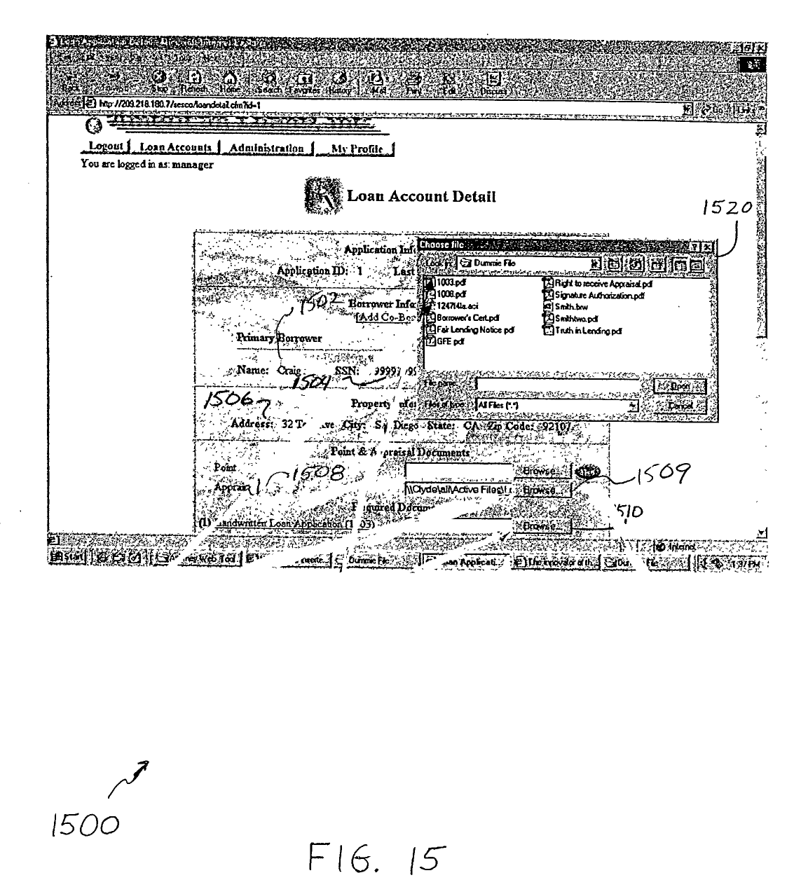

FIG. 15 is a diagram of a loan account detail screen display 1500 with a file upload feature as shown in the primary interface diagram 900 of FIG. 9. The loan account detail display 1500 (loandetail.cfm 934 in FIG. 9) may include loan application information, for example borrower information such as name 1502 or social security number 1504, property information 1506, loan document names 1508 and file locations 1509, or other loan application information. A file upload browse selection button 1510 displays a choose file display window 1520 for choosing a stored file for uploading with the loan application information. While the display 1500 shown in FIG. 15 is for a manager, corresponding displays for other users may also exist, which may be the same as shown in FIG. 15 or may be different. Although not shown in this figure, files may also be downloaded in a similar manner as that just described.

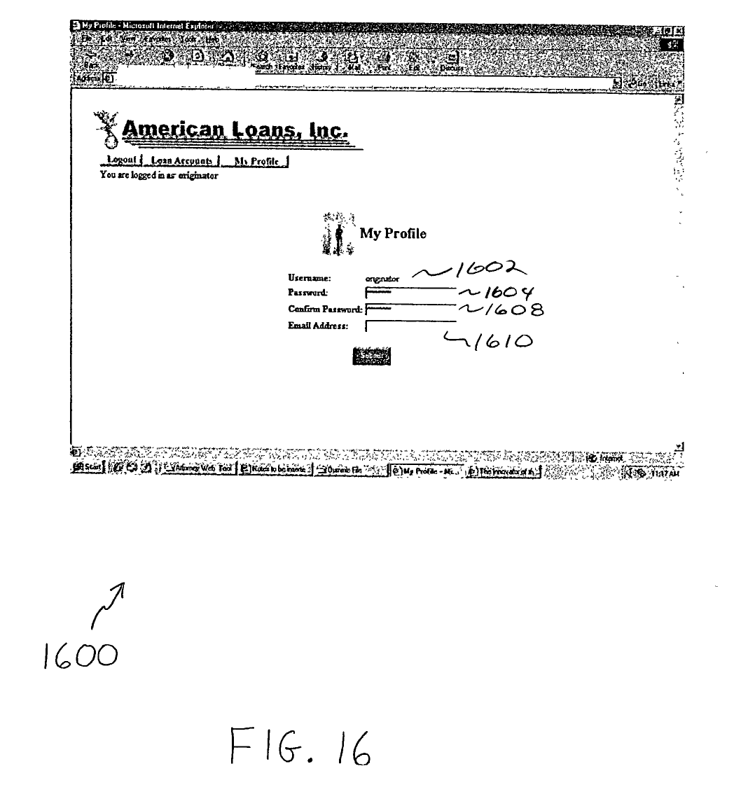

FIG. 16 is a diagram of a user profile screen display 1600 as shown in the primary interface diagram of FIG. 9. The user profile display 1600 (myprofile.cfm 926 in FIG. 9) may include user profile information, for example username 1602, password 1604, password confirmation 1608, email address 1610, or other user profile information. While the user profile display 1600 shown in FIG. 16 is for an originator, corresponding displays for other users may also exist, which may be the same as shown in FIG. 16 or may be different.

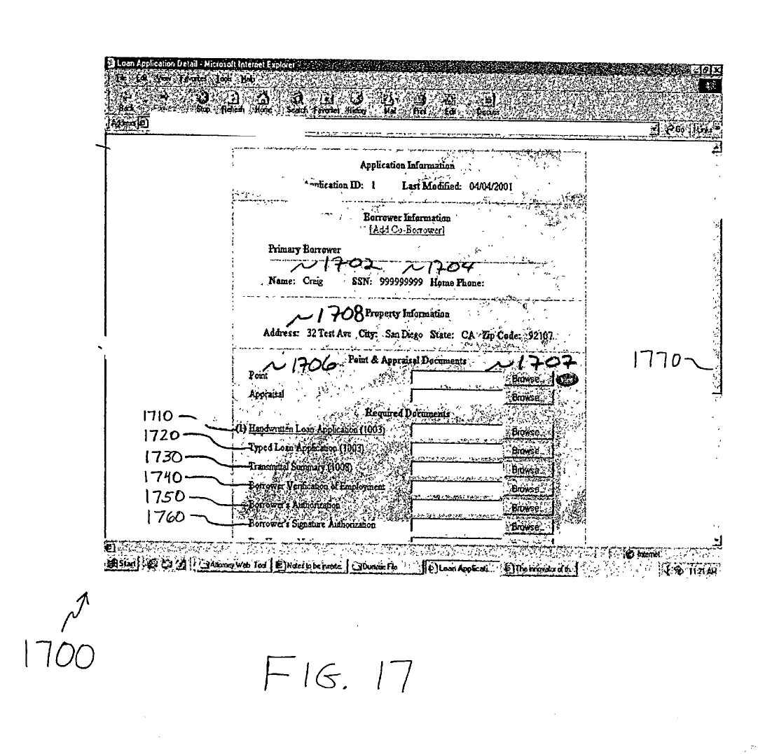

FIG. 17 is a diagram of a loan account detail screen display 1700 as shown in the primary interface diagram of FIG. 9. The loan account detail display 1500 (loandetail.cfm 934 in FIG. 9) may include loan application information, for example borrower information such as name 1702, social security number 1704, property information 1708, loan document names 1706 and file locations 1707, or other loan application information. The display 1700 shown in FIG. 17 is similar to the loan account detail display 1500 in FIG. 15, but without the upload file feature shown. The display 1700 in FIG. 17 also shows additional required documents that are not shown in FIG. 15, including a handwritten loan application 1710, a typed loan application 1720, a transmittal summary 1730, a borrower verification of employment document 1740, a borrower's authorization document 1750, and a borrower's signature authorization 1760. Additional documents may similarly be shown in the loan account detail display 1700 shown in FIG. 17, for example by scrolling down using a scrollbar 1770.

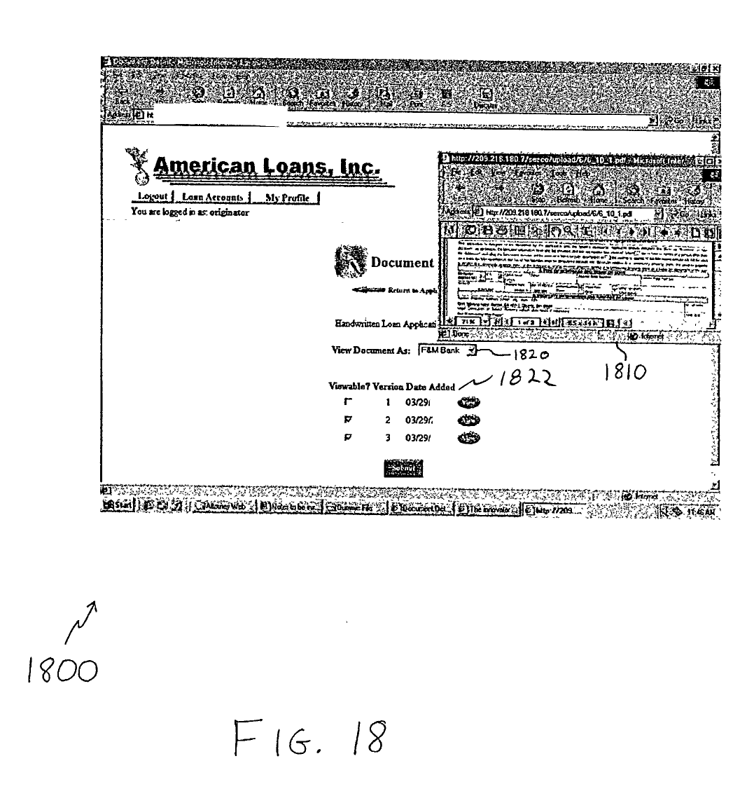

FIG. 18 is a diagram of a document detail screen display 1800 with original file format view feature 1810 as shown in the primary interface diagram of FIG. 9. The document detail display 1800 (docdetail.cfm 954 in FIG. 9) may include document attributes and other information, for example a name to view the document as 1820, a document version identifier (not shown), a date the documents were added 1822, or other document attribute information. The documents may additionally be viewed in the original saved format via another display window 1810 as previously described.

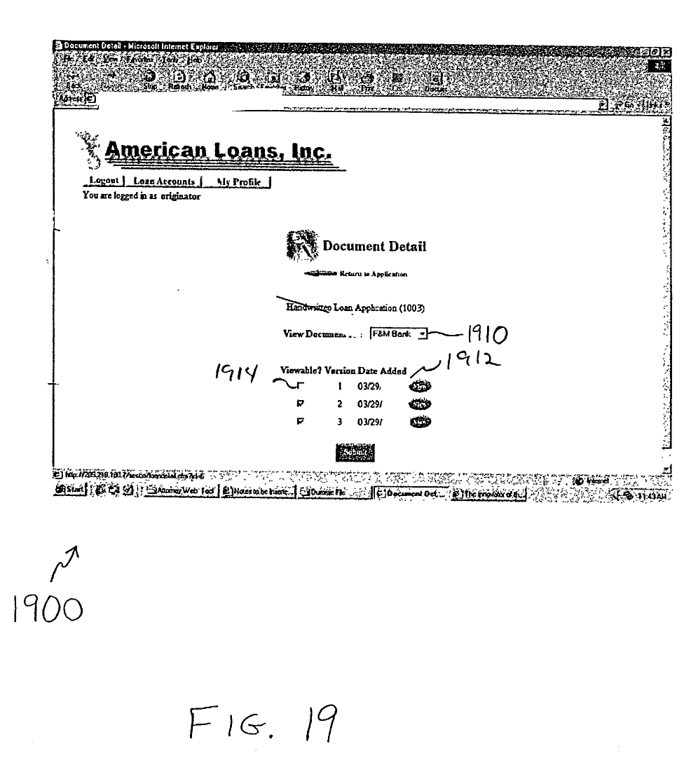

FIG. 19 is a diagram of a document detail screen display 1900 as shown in the primary interface diagram of FIG. 9. The document detail display 1900 (docdetail.cfm 954 in FIG. 9) may include document attributes and other information, for example a name to view the document as 1910, document version identifiers (not shown), a date the documents were added 1912, or other document attribute information. Additionally, a superuser may use the view selection buttons 1914 to set whether or not other users of the electronic document processing system may view the electronic documents. For example, the superuser may determine that an originator may not view a particular document in which case the superuser deselects the document as viewable. The display 1900 shown in FIG. 19 is similar to the document detail display 1800 in FIG. 18, but without the view documents in their original form 1810 feature shown.

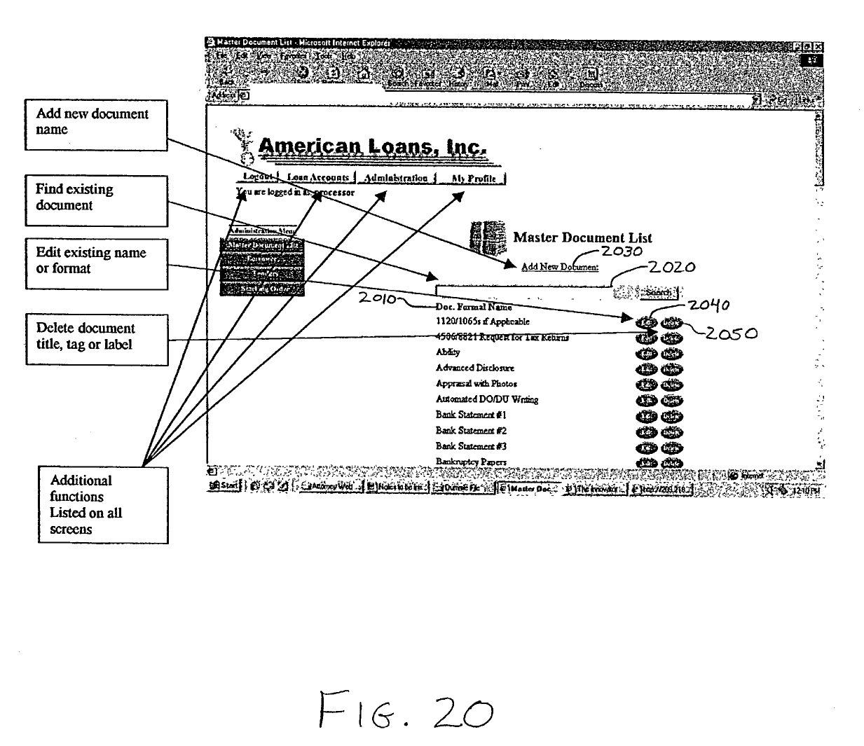

FIG. 20 is a diagram of a master document list screen display 2000 as shown in the administration interface diagram of FIG. 10. The master document list display 2000 (mdl.cfm 1014 in FIG. 10) may include master document list information and features, for example a document formal name 2010, a document search selection field 2020, an add new document name selection 2030, an edit existing name or format selection button 2040, a delete document title, tag or label button 2050, or other document list information or features. The master document list screen display is used by a processor to perform the processor's duties. The files available to a processor are limited by the determination of the superuser. A superuser may restrict a processor from accessing electronic documents included in a loan application after the loan application has been closed. Additionally, a processor may only see those electronic documents included in a loan application assigned to the borrower.

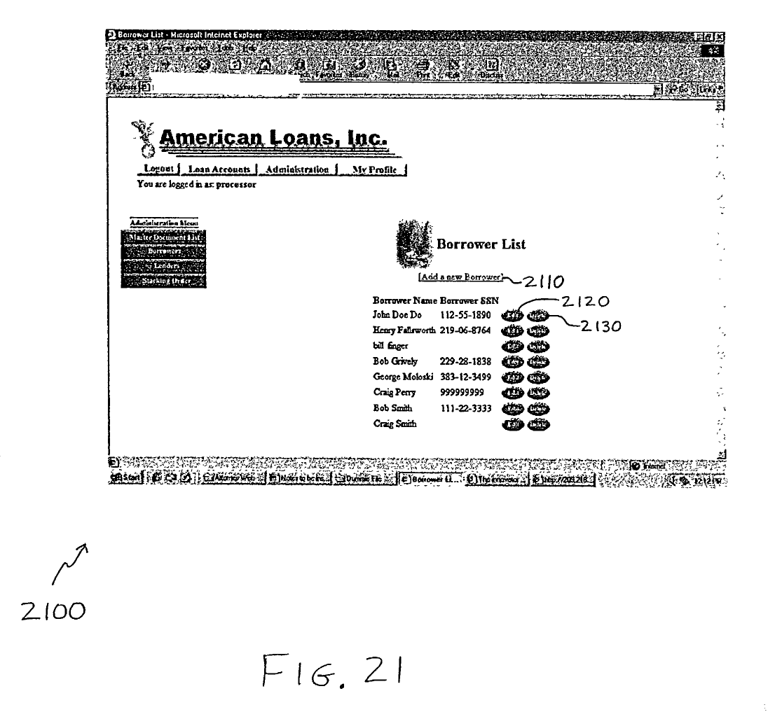

FIG. 21 is a diagram of a borrower list screen display 2100 as shown in the administration interface diagram of FIG. 10. The borrower list display 2100 (borrower.cfm 1018 in FIG. 10) may include borrower list information and features, for example an add new borrower selection 2110, an edit existing borrower information selection button 2120, a delete borrower button 2130, or other borrower list information or features. While the borrower list display 2100 shown in FIG. 21 is for a processor, corresponding displays for other users may also exist, which may be the same as shown in FIG. 21 or may be different.

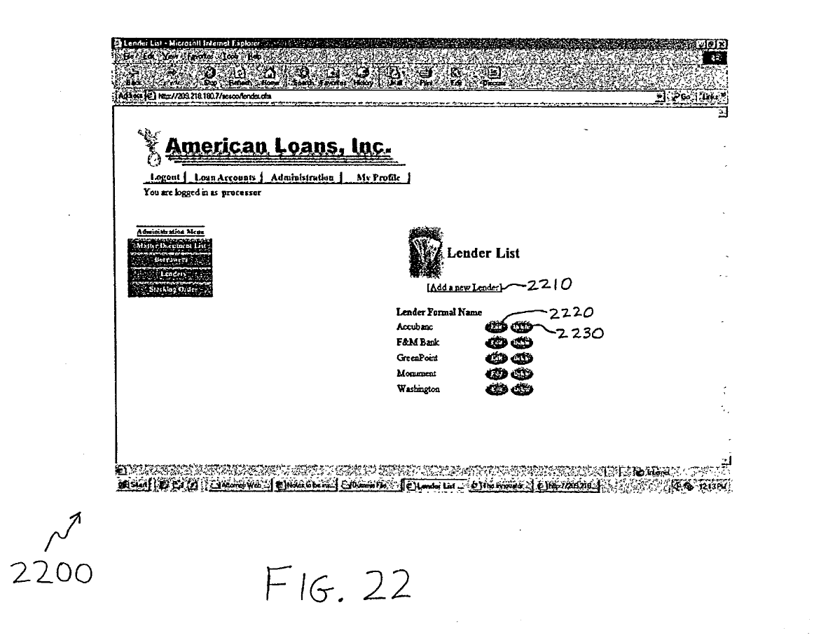

FIG. 22 is a diagram of a lender list screen display 2200 as shown in the administration interface diagram of FIG. 10. The lender list display 2200 (lender.cfm 1022 in FIG. 10) may include lender list information and features, for example an add new lender selection 2210, an edit existing lender information selection button 2220, a delete lender button 2230, or other lender list information or features. A superuser may restrict a processor's ability to edit the lender list. Once a lender has been assigned to a loan application, the lender is sent an access code by email. While the lender list display 2200 shown in FIG. 22 is for a processor, corresponding displays for other users may also exist, which may be the same as shown in FIG. 22 or may be different.

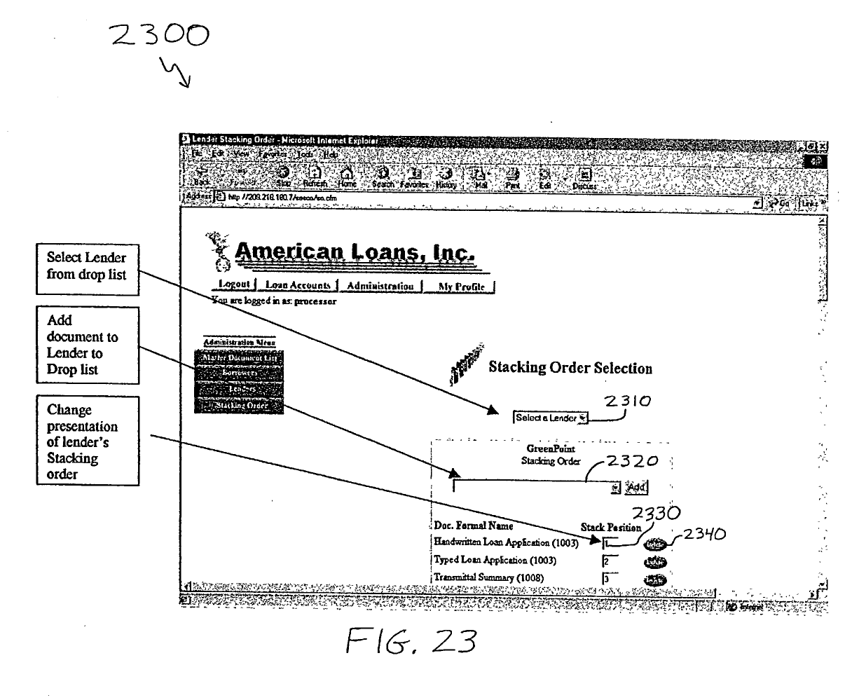

FIG. 23 is a diagram of a stacking order selection screen display 2300 as shown in the administration interface diagram of FIG. 10. Each lender typically has preferences with regards to processing a loan application. One such preference is the order in which each of the documents included in a loan application is placed, or “stacked” into a file. An embodiment of an electronic document processing system in accordance with the present invention includes the ability to create a stacking order for the electronic documents. Each lender can be assigned a separate stacking order and the same loan application can be viewed by different lenders using different stacking orders. The stacking order selection display 2300 (so.cfm 1026 in FIG. 10) may include stacking order selection information and features, for example a select a lender selection 2310, for example a drop list user interface feature, an add document to lender list 2320, one or more change presentation of lender stacking order entry fields 2330 for each document listed, a delete document from lender stacking order selection button 2340, or other stacking order selection information or features. While the stacking order selection display 2300 shown in FIG. 23 is for a processor user, corresponding displays for other users may also exist, which may be the same as shown in FIG. 23 or may be different.

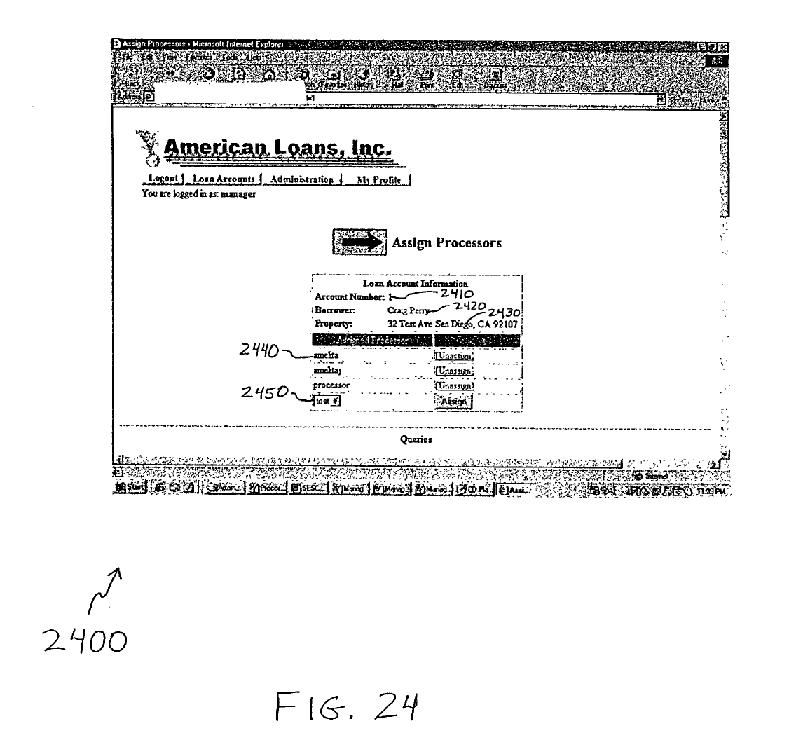

FIG. 24 is a diagram of an assign processors screen display 2400 as shown in the primary interface diagram of FIG. 9. The assign processors display 2400 (assignprocessor.cfm 946 in FIG. 9) may include assign processor information and features, for example loan account information including but not limited to account number 2410, borrower name 2420 or property address 2430, a list of available assigned processor names 2440, a list of additional processors 2450 that may be assigned, or other assign processor information or features. A manager uses the assign processor screen to assign processors to individual loan applications. A plurality of processors may be assigned to a single loan application. While the assign processor display 2400 shown in FIG. 24 is for a manager, corresponding displays for other users may also exist, which may be the same as shown in FIG. 24 or may be different.

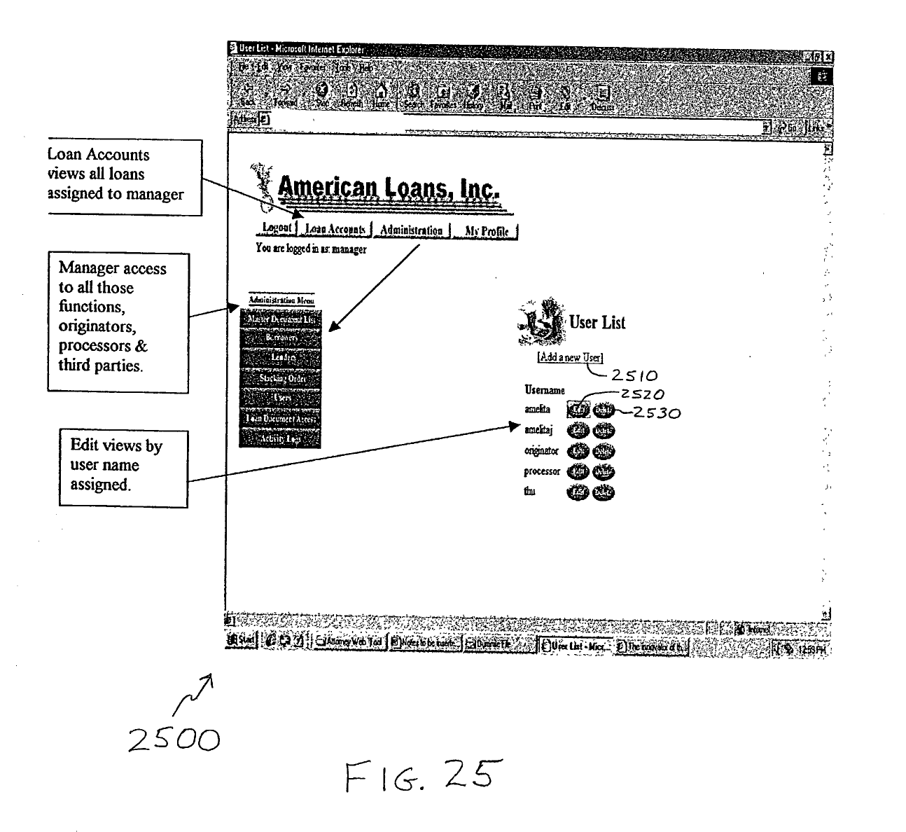

FIG. 25 is a diagram of a user list screen display 2500 as shown in the administration interface diagram of FIG. 10. The user list display 2500 (user.cfm 1030 in FIG. 10) may include user list information and features, for example an add new user selection 2510, an edit existing user information selection button 2520, a delete user button 2530, or other user list information or features. While the user list display 2500 shown in FIG. 25 is for a manager, corresponding displays for other users may also exist, which may be the same as shown in FIG. 25 or may be different.

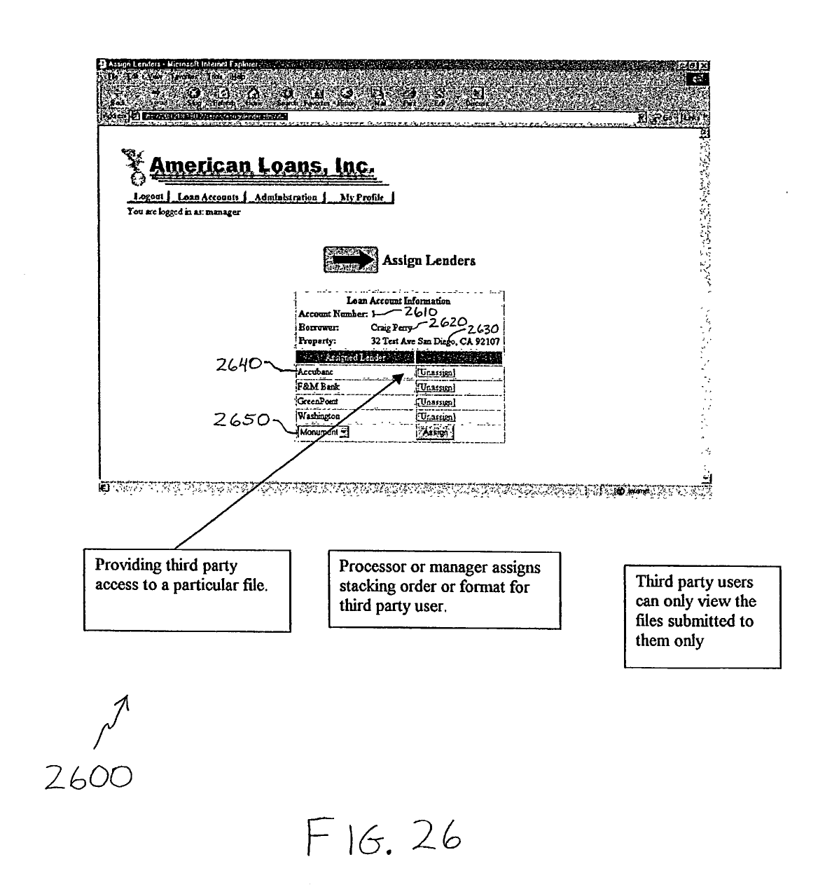

FIG. 26 is a diagram of an assign lenders screen display 2600 as shown in the primary interface diagram of FIG. 9. The assign lenders display 2600 (assignlender.cfm 942 in FIG. 9) may include assign lender information and features, for example loan account information including but not limited to account number 2610, borrower name 2620 or property address 2630, a list of available assigned lender names 2640 to allow providing a third party lender access to a particular file or files, a list of additional lenders 2650 that may be assigned, or other assign lender information or features. A lender can only access those filed assigned to the lender by the manager. While the assign lender display 2500 shown in FIG. 25 is for a manager, corresponding displays for other users may also exist, which may be the same as shown in FIG. 25 or may be different.

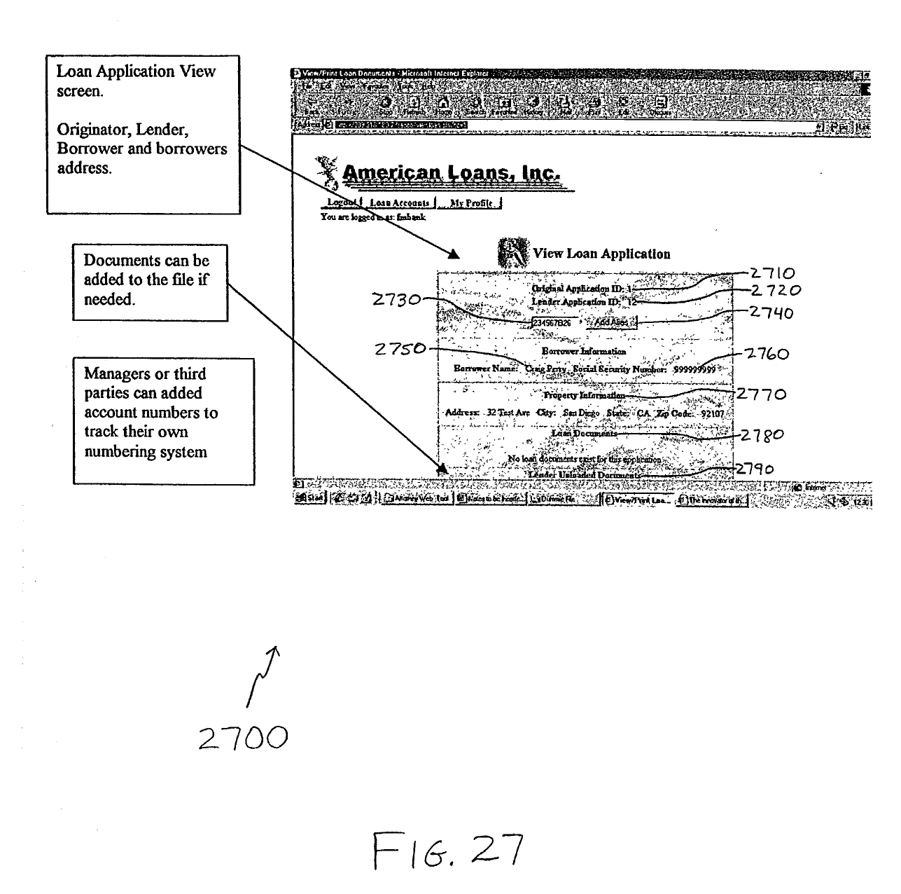

FIG. 27 is a diagram of a view loan application screen display 2700 as shown in the primary interface diagram of FIG. 9. The view loan application screen display is used by a third party, such as a lender, to view a loan application including electronic documents. The view loan application display 2700 (viewloan_ghost.cfm 930 in FIG. 9) may include loan application information, for example application identifier 2710, lender application identifier 2720, add alias entry field 2730 or selection button 2740, borrower information such as borrower name 2750 or social security number 2760, property information 2770, loan document information 2780, lender unloaded documents 2790, or other loan application information. While the view loan application display 2700 shown in FIG. 27 is for a third party lender, corresponding displays for other users may also exist, which may be the same as shown in FIG. 27 or may be different.

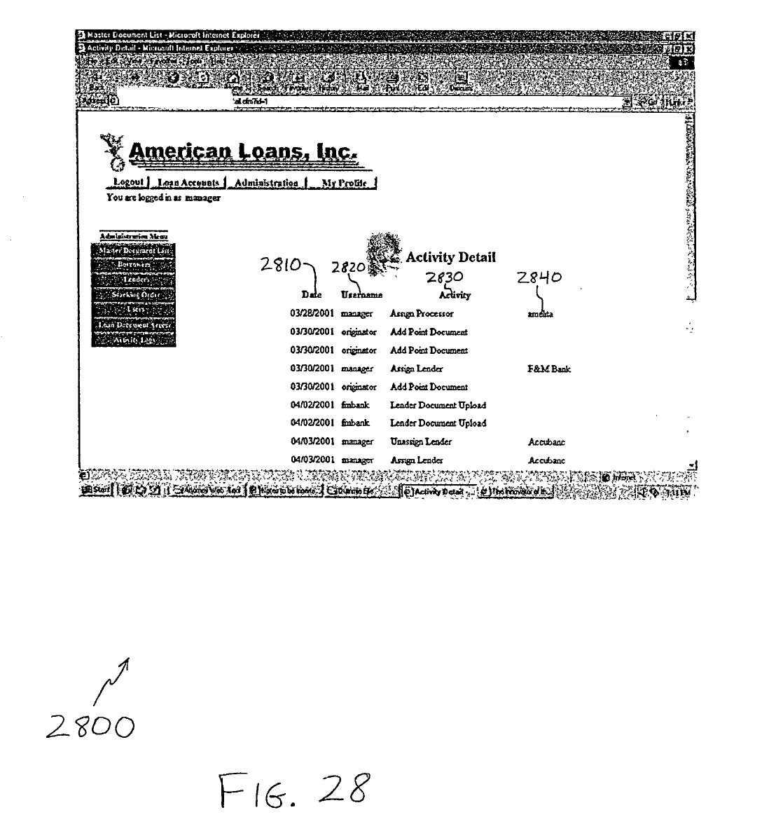

FIG. 28 is a diagram of an activity detail screen display 2800 as shown in the administration interface diagram of FIG. 10. The activity detail display 2800 (activitydetail.cfm 1066 in FIG. 10) may include activity detail information, for example a date 2810 for the occurrence of an activity, a username 2820 identifying the user performing the activity, an activity description 2830 identifying the nature of the activity performed, a user or recipient 2840 for activities which include a recipient, or other activity detail information. While the activity detail display 2800 shown in FIG. 28 is for manager, corresponding displays for other users may also exist, which may be the same as shown in FIG. 28 or may be different.

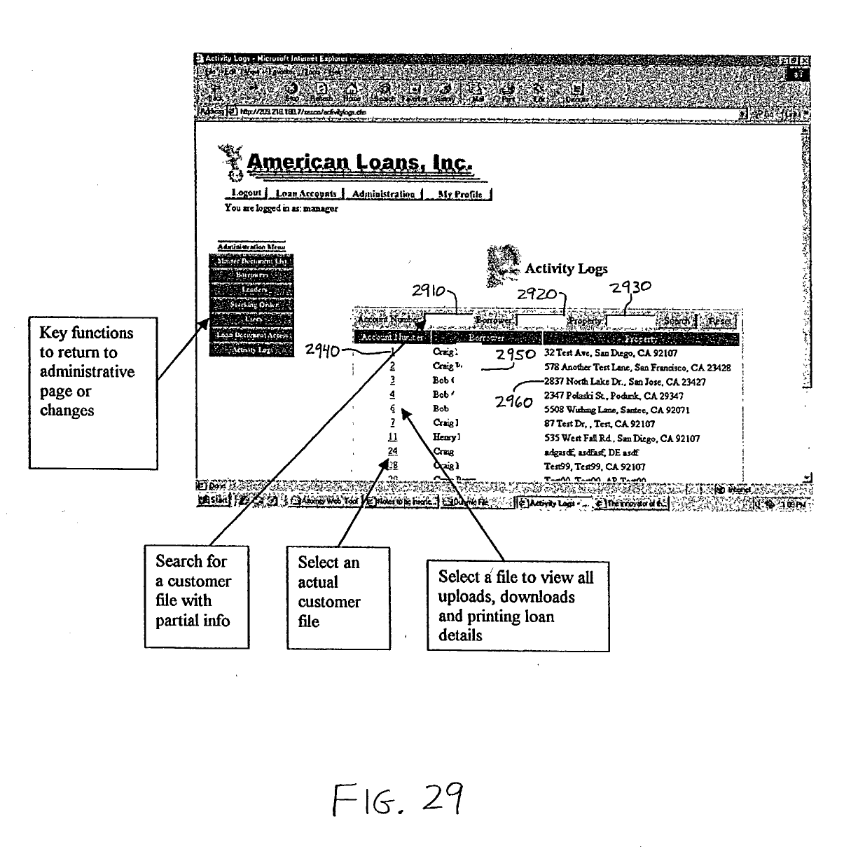

FIG. 29 is a diagram of an activity logs screen display 2900 as shown in the administration interface diagram of FIG. 10. The activity logs display 2900 (activitylogs.cfm 1038 in FIG. 10) may include information relating to a list of available borrower accounts or applications from which to select for viewing the activity detail display 2800 as described in FIG. 28. The activity logs display 2900 may include search entry fields for account number 2910, borrower name 2920 or property address 2930 for entry of partial information for searching, account number list 2940 for selecting an actual customer file to view account information such as uploaded files or downloaded files or to print loan detail information. The activity logs display 2900 may additionally include a list of borrower names 2950 to assist identification of the account number 2940, or a list of property addresses 2960 to further assist identification of the account number 2940. While the activity logs display 2900 shown in FIG. 29 is for a manager, corresponding displays for other users may also exist, which may be the same as shown in FIG. 29 or may be different.

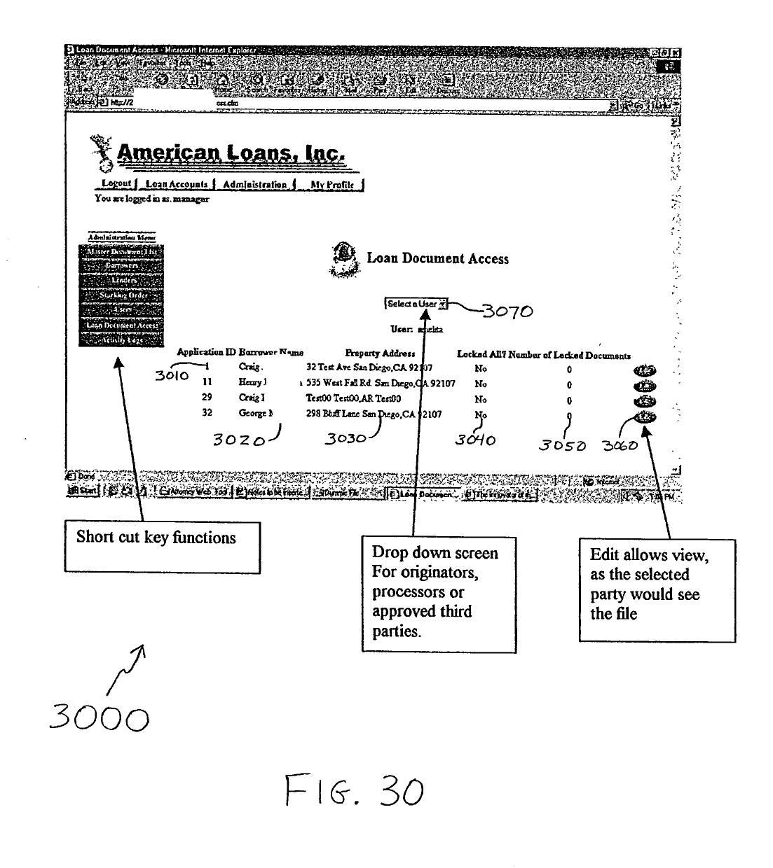

FIG. 30 is a diagram of a loan document access screen display 3000 as shown in the administration interface diagram of FIG. 10. The loan document access display 3000 (docaccess.cfm 1034 in FIG. 10) may include information relating to access attributes for one or more borrower accounts or applications, for example an application identifier 3010, borrower name 3020, property address 3030, indication whether all documents are locked 3040, indication as to the number of locked documents, a document edit button 3060 allowing selection of the loan application document access attributes to view or alter, or other loan document access information. The loan document access display 3000 may additionally include a capability to select a user 3070 for viewing loan document access information, for example a drop down list user interface feature. While the loan document access display 3000 shown in FIG. 30 is for a manager, corresponding displays for other users may also exist, which may be the same as shown in FIG. 30 or may be different.

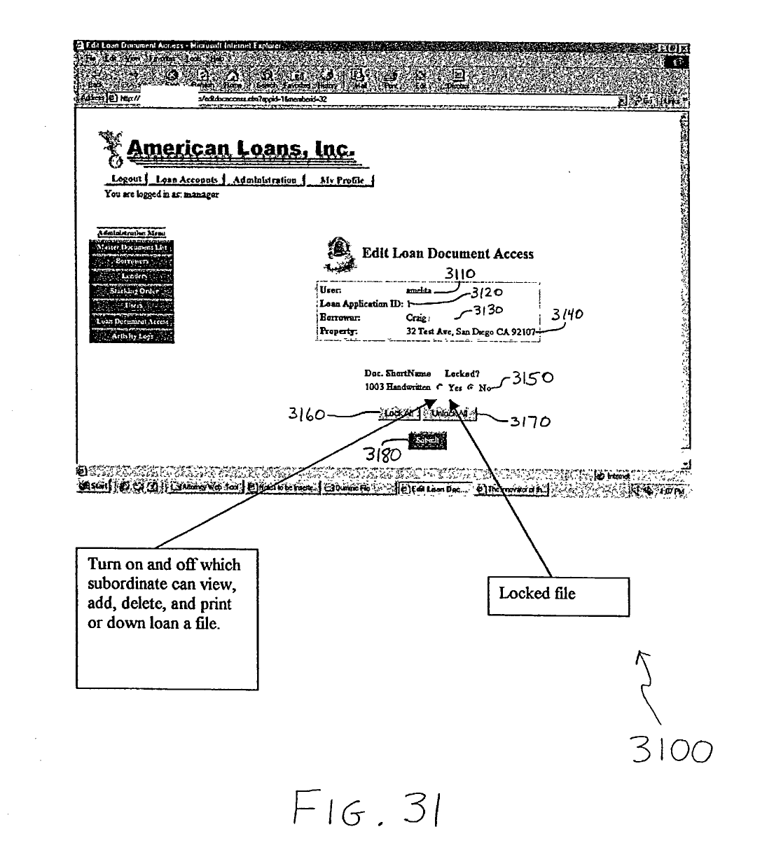

FIG. 31 is a diagram of an edit loan document access screen display 3100 as shown in the administration interface diagram of FIG. 10. The edit loan document access display 3100 (editdocaccess.cfm 1082 in FIG. 10) may include information relating to access attributes for a borrower account or application as selected via the loan document access display 3000 in FIG. 30. The information may include, for example, a username 3110, application identifier 3120, borrower name 3130, property address 3140, or other loan application information. The edit loan document access display 3100 may additionally include the capability to alter the access attributes for the displayed account or application, for example selection buttons 3150 to lock or unlock documents individually, a selection button 3160 to specify that all documents for the viewed account or application have the locked attribute, a selection button 3170 to specify that all documents for the viewed account or application have the unlocked attribute, or other access information. A submit user interface button may further be included to submit to the processing system 200 the user-entered access information. While the loan document access display 3100 shown in FIG. 31 is for a manager, corresponding displays for other users may also exist, which may be the same as shown in FIG. 31 or may be different.

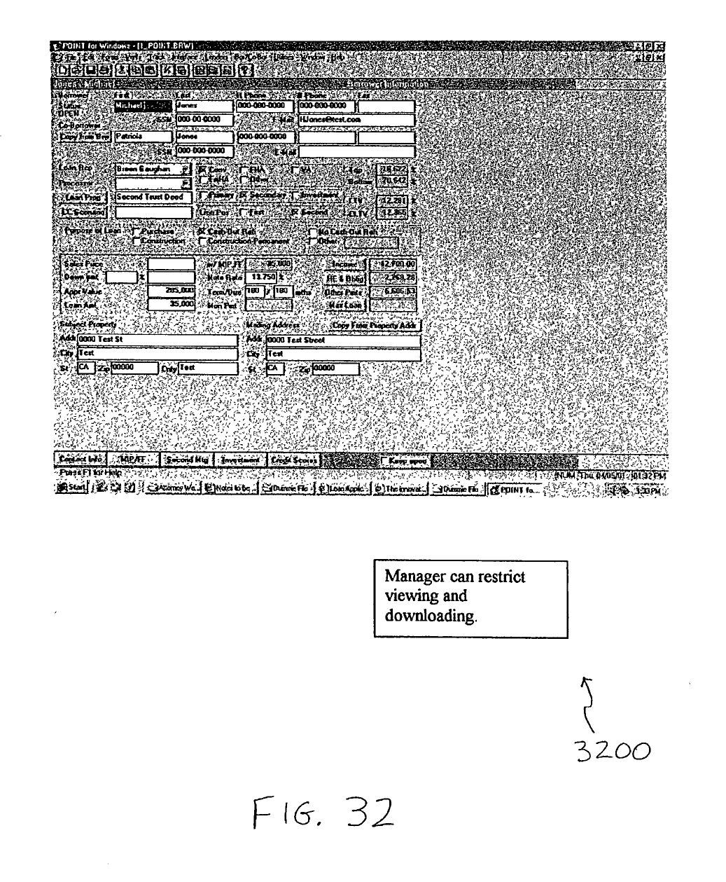

FIG. 32 is a diagram of a point program view screen display 3200 of the electronic document processing system 200 of FIG. 2. The point program view display 3200 shows information that may be displayed relating to borrower information, for example by utilizing an application program such as the Point program for Windows.

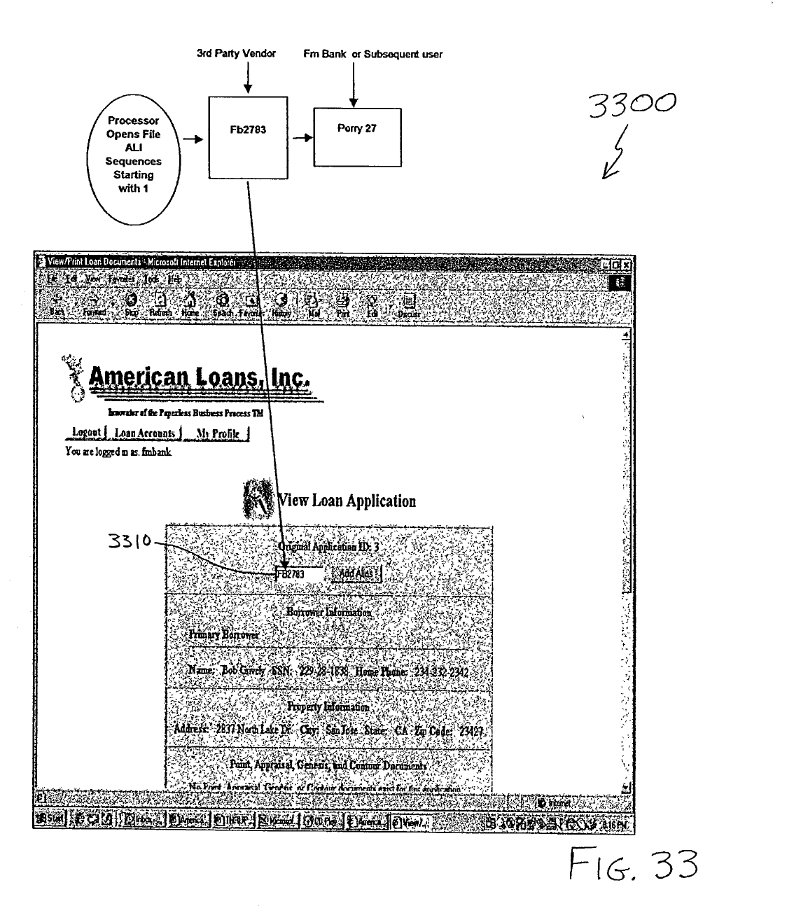

FIG. 33 is a diagram of a view loan application screen display 3300 of the electronic document processing system of FIG. 2. The view loan application display 3300 shown in FIG. 33 is similar to the display 2700 shown in FIG. 27, and additionally demonstrates the document naming and aliasing available to third party users of the processing system 200. In the example of FIG. 33, a lender has assigned an identifier 3310 to the viewed application. While the view loan application display 3300 shown in FIG. 33 is for a third party lender, corresponding displays for other users may also exist, which may be the same as shown in FIG. 33 or may be different.

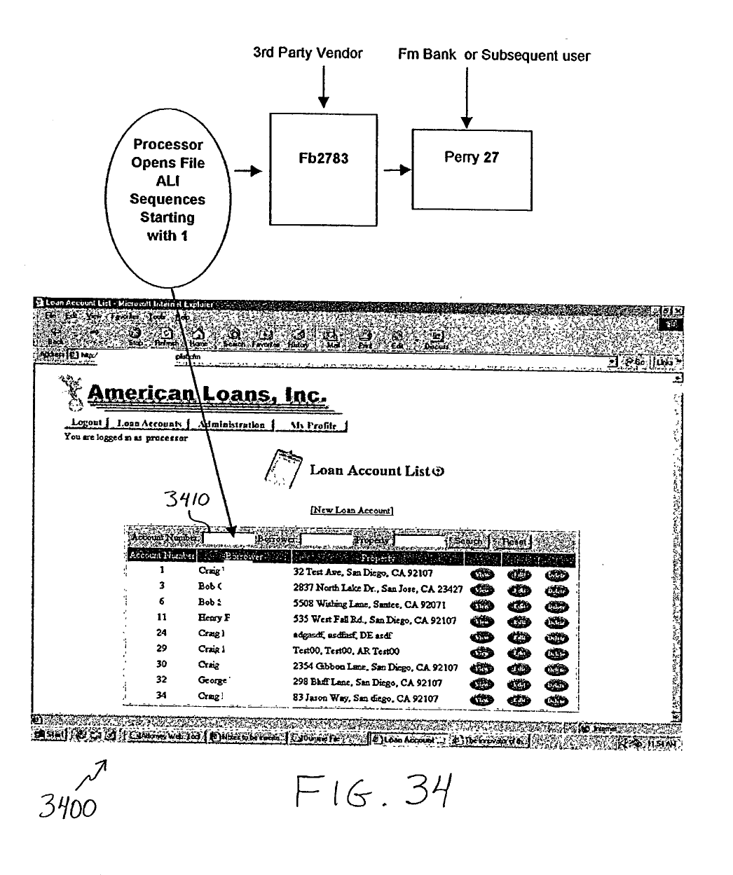

FIG. 34 is a diagram of a loan account list screen display 3400 as shown in the primary interface diagram of FIG. 9. The view loan application display 3400 shown in FIG. 34 is similar to the display 1100 shown in FIG. 11, and additionally demonstrates the document name and alias searching capabilities available to third party users of the processing system 200. In the example of FIG. 34, a lender may search for a document by entering a document identifier defined by the lender in the account number search field 3410. While the loan account list display 3400 shown in FIG. 34 is for a processor user, corresponding displays for other users may also exist, which may be the same as shown in FIG. 34 or may be different.

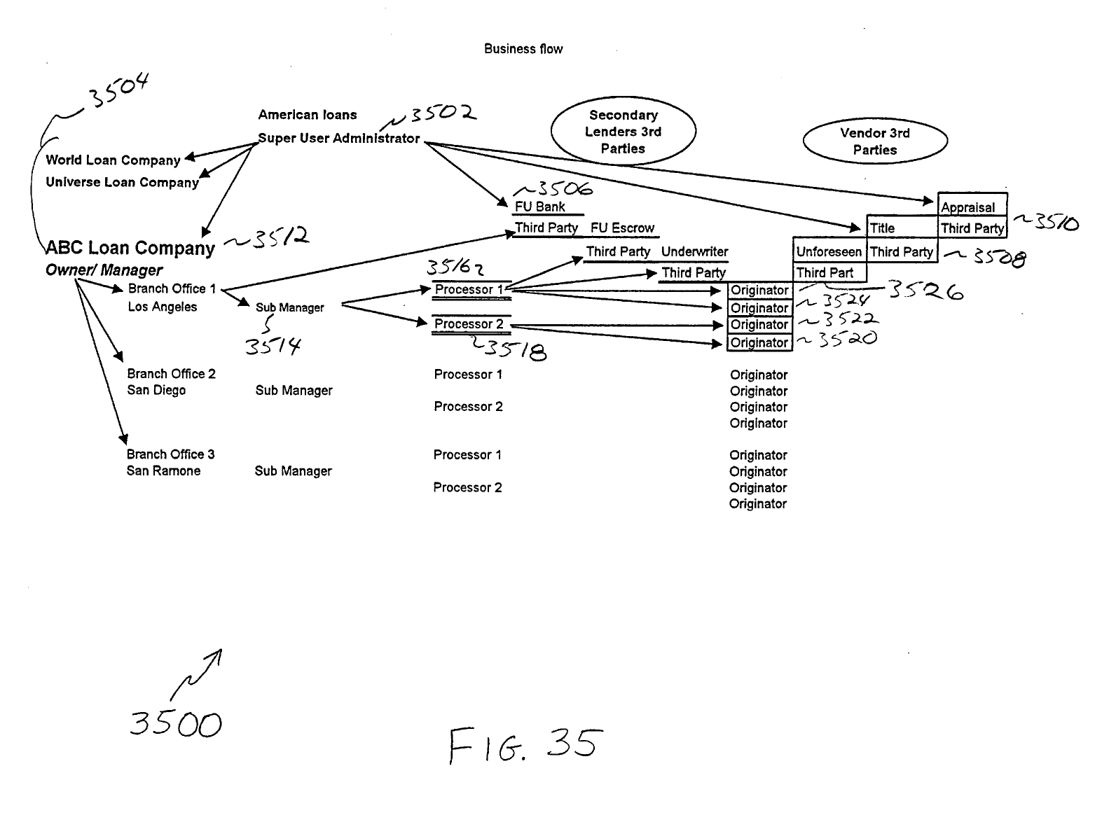

FIG. 35 is a diagram of an embodiment of a business flow of the electronic document processing system of FIG. 2. A superuser 3502 can serve as an administrator for a plurality of managers 3504, a plurality of lenders 3506, and a plurality of third parties such as third parties to handle title insurance 3508 and appraisals 3510. Each manager can create and serve as an administrator for a plurality of sub-managers 3514. A sub-manager can create and serve as an administrator for a plurality of processors such as processor 1 3516 and processor 2 3518. Each processor can create and serve as an administrator for a plurality of originators 3520, 3522, 3524, and 3526. Each administrator can alter the privileges of any of the users on any of the layers beneath the administrator. For example, the superuser can alter the privileges of any of the originators 3520, 3522, 3524, and 3526.

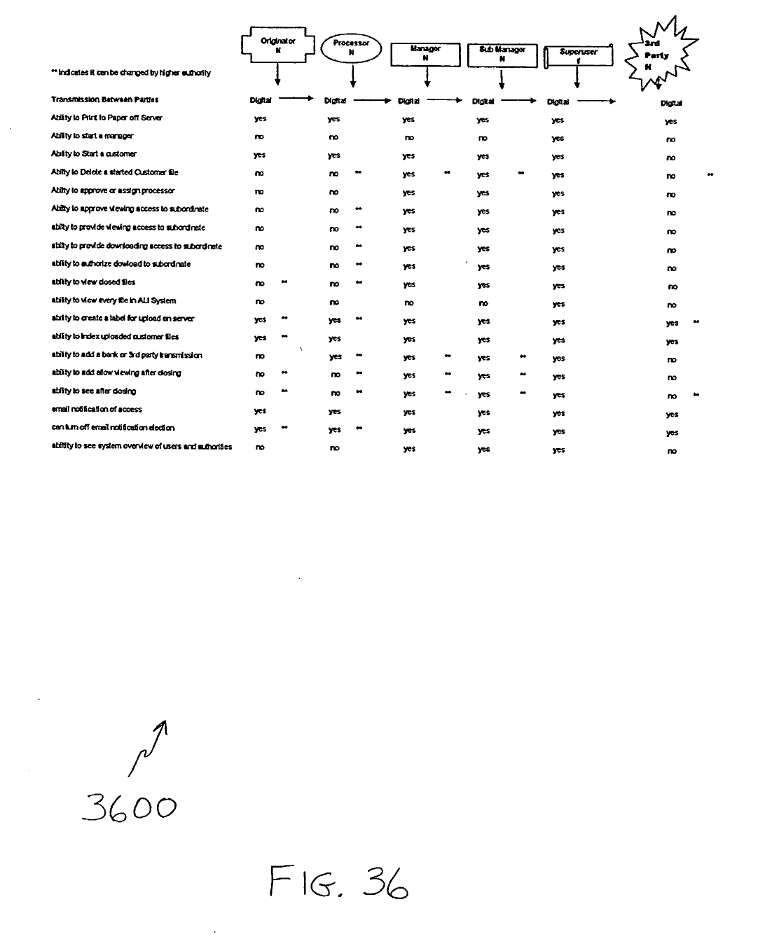

FIG. 36 is a diagram of an embodiment of a table of user access settings 3600 of the electronic document processing system of FIG. 2. The access settings and attributes shown in FIG. 36 represent one example of default access control for a processing system 200. The table 3600 illustrates the operations and capabilities that are available to various users of the system. There may be other users and capabilities in the processing system 200 that are not shown in this diagram, as well as other available states in addition to “yes” or “no” as shown in this diagram. Additionally, the default access attributes show in the table 3600 may optionally be altered by certain users in the operation of the processing system 200.

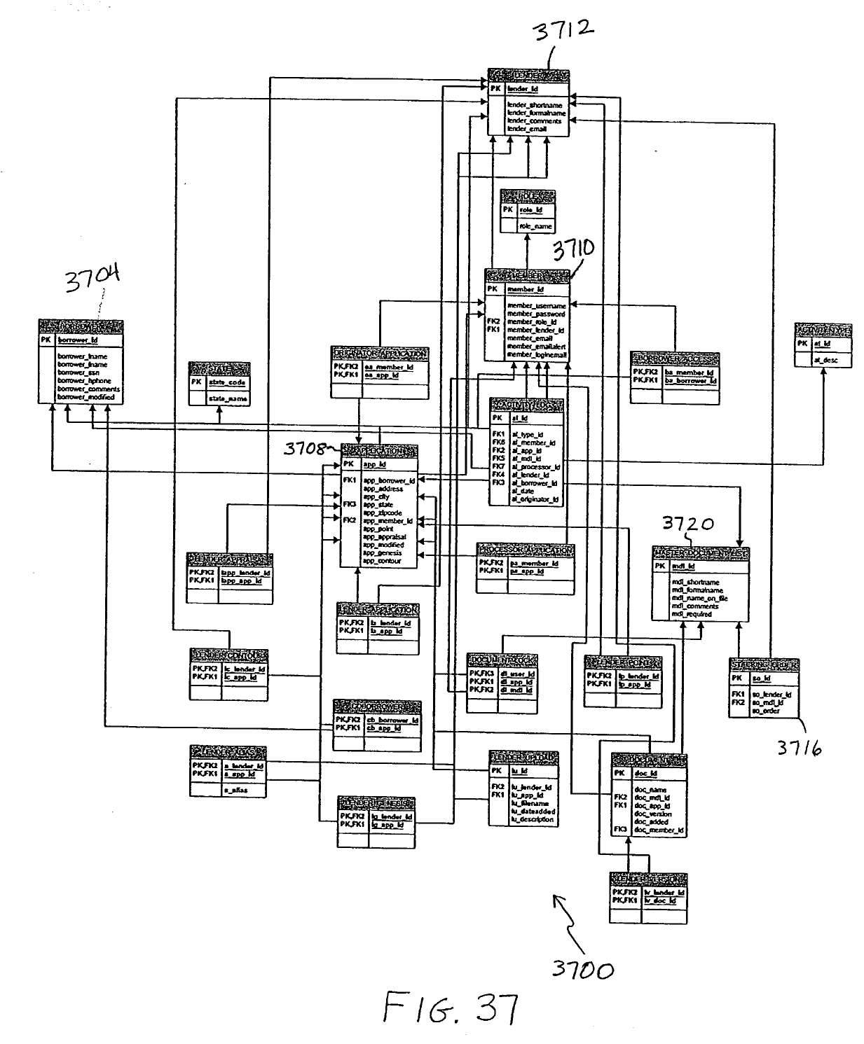

FIG. 37 is a block diagram illustrating the data tables 3700 that are maintained by the database in the document server 240 (see FIG. 2) in one embodiment of the invention. A description of each of the data tables is described in further detail in Appendix A. It is noted that depending on the embodiment, other tables may be added, others deleted, and the organization of the tables may be rearranged.

A borrower table 3704 contains information describing each of the borrowers. Each borrower is associated with a borrower identification number. An application table 3708 describes information regarding each mortgage loan application that has been submitted to the document server 240. The application table 3708 includes, among other items, the borrower identification number, a member identification number, or an application state identifier. The member identification number is associated with each administrative employee that has access to the document server.

A member identification table 3710 stores information that relates to a selected member identification number. For a selected member identification number, the member identification table identifies the member's username, password, email address, or information describing whether the user desires to receive email and login alerts. Each time a user name is used to access an account, the user corresponding to the user name is sent an email alert. The user can then use the email alert to either monitor and log their own activity on the electronic document processing system or monitor unauthorized access. A lender table 3712 contains the lender information for a selected application. Information included within the lender table 3712 may include a short name for the lender, the lender's formal name, lender comments, or the lender's email address.

A stacking order table 3716 contains information describing the stacking order of each of the documents that are maintained by the document server 240 with respect to each lender. Using the document server 240, each lender may have its own associated stacking order. A master document list table 3720 contains information describing the documents for a selected application. Information included within the master document list table 3720 may include a short name for the document, a document's formal name, a name to be displayed for each document, a comment field for further identifying the documents, or a field identifying whether each document is required for the application.

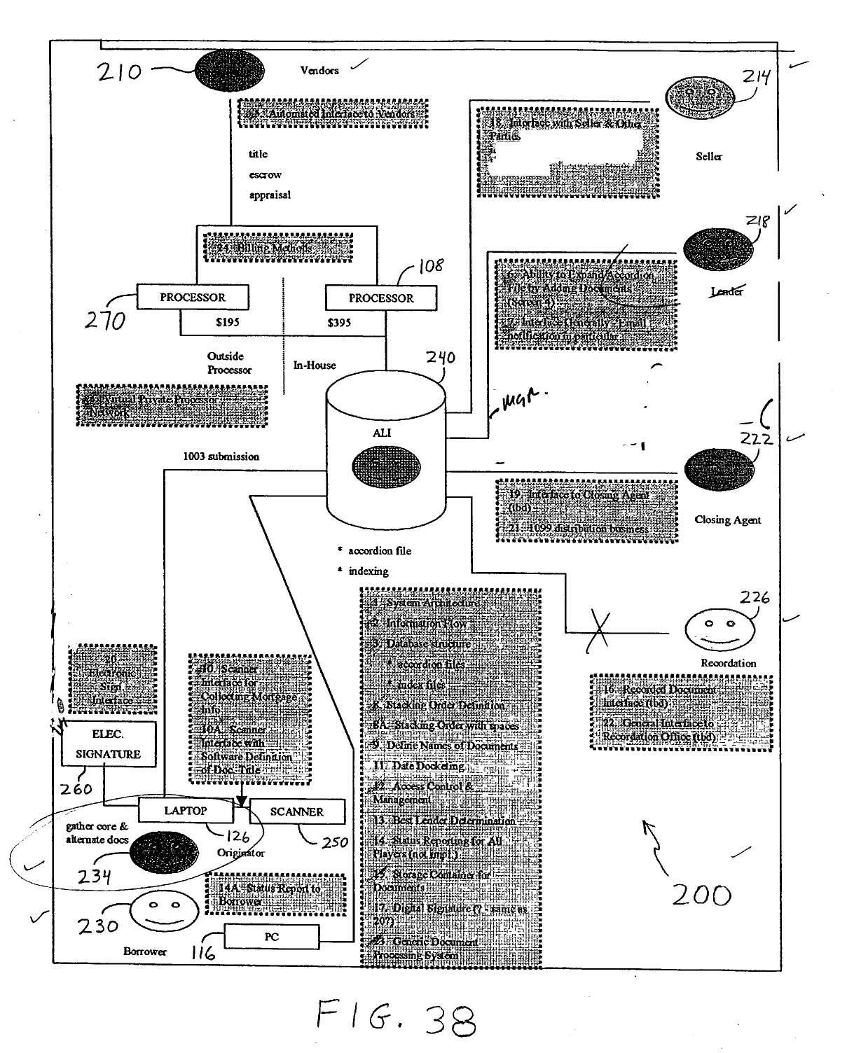

FIG. 38 is a block diagram of an electronic document processing system architecture 200 in accordance with an exemplary embodiment of the present invention. The system 200 includes a plurality of user interfaces to permit a variety of types of users to log in to, access, use and update the system 200. In the embodiment of FIG. 2, the users shown include vendors 210, sellers 214, lenders 218, closing agents 222, recordation users 226, borrowers 230, originators 234, and managers. The manager user may be embodied in the document server 240 of FIG. 2. The system 200 includes user interfaces for the types of users, one or more of which may be in common with another type or types of users. The user interface includes displaying information to a user in a textual format, graphical format, or other manners of transmitting information to a user of an electronic device. The user interface additionally includes receiving information or selections input from a user via a computing device, including for example using a mouse device, a keyboard, keypad, voice recognition, touch screens, or other manner by which a user conveys data or information to an electronic device.

The electronic document processing system 200 embodiment of FIG. 2 may additionally include a scanning device 250. One example of such a scanning device 250 is an optical scanner, which can read text or illustrations printed on paper and translate the information into a computer-readable form. An optical scanner digitizes an image by dividing it into a grid of boxes and representing each box with either a zero or a one, depending on whether the box is filled in. The resulting array of bits, called a bitmap, may be stored in a file on a storage device, displayed on a screen, or manipulated by image editing applications. The scanning process does not typically distinguish text from illustrations; rather all images are represented as bitmaps. In this case, a user may not directly edit text that has been scanned without an optical character recognition (OCR) system to translate the textual image into characters. Optical scanners typically include OCR packages.

The electronic document processing system 200 embodiment of FIG. 2 may additionally include an electronic signature 260 feature. An electronic or digital signature 260 may typically include a digital code that can be attached to an electronic message or file that uniquely identifies the sender. Like a written signature, a digital signature 260 serves to authenticate and identify the individual sending or signing the file. Digital signatures 260 are more effective if they are unforgeable. There are a number of different encryption techniques to support this level of security.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents.

What is claimed is:

1. A system for processing electronic documents, comprising:
an electronic document server including:
electronic document originator access rules; and
electronic document recipient access rules;
an originator interface for receiving an electronic document by the electronic document server from an originator in accordance with the electronic document originator access rules; and
a recipient interface for transmitting the electronic document by the electronic document server to a recipient in accordance with the electronic document recipient access rules.

2. The system of claim 1, wherein the electronic document originator access rules prevent the originator from modifying the electronic document received by the document server from the originator.

3. The system of claim 1, wherein the electronic document originator access rules prevent the originator from viewing a second electronic document received by the document server from a second originator.

4. The system of claim 3, wherein the electronic document recipient access rules allow a recipient to view the electronic document and the second electronic document.

5. The system of claim 1, wherein the document server further includes electronic document processor access rules, the system further comprising a processor interface for processing the electronic document by a processor in accordance with the electronic document processor access rules.

6. The system of claim 5, wherein the document server includes electronic document manager access rules, the system further comprising a manager interface for managing the electronic documents by a manager in accordance with the electronic document manager access rules.

7. The system of claim 1, the document server further including an expandable electronic file.

8. The system of claim 7, wherein the electronic document recipient access rules include a stacking order for organizing electronic documents stored in the expandable electronic file and transmitted to the recipient.

9. The system of claim 1, further comprising a scanner for generating scanned electronic documents, wherein the scanned electronic documents are transmitted to the electronic document server via the originator interface.

10. The system of claim 9, further comprising an interface for identifying a name and a document type for the scanned document.

11. The system of claim 1, further comprising a superuser interface for defining the electronic document originator access rules and the electronic document recipient access rules.

12. A system for processing electronic loan documents, the system comprising:
a loan document server including a plurality of electronic loan documents for a plurality of electronic loan applications and a database of information describing the electronic loan documents for each of the electronic loan applications, wherein the database defines a stacking order for the electronic loan documents for each of a plurality of lenders; and
a lender interface for viewing the electronic documents, wherein the electronic documents are arranged and displayed in the stacking order that is defined by the database of information.

13. The system of claim 12, wherein each document of a selected type is sequenced in the stacking order contiguously with other documents of the same type.

14. A system for processing electronic documents, the system comprising:
a document server including:
a plurality of electronic documents,
a database of information describing the electronic documents, and
an administrative interface for identifying the name of the electronic documents, wherein the name of a selected electronic document is definable on a lender by lender basis, and wherein the defined names are stored in the database of information; and
a lender interface for viewing the electronic documents, wherein the names of the electronic documents are named in accordance with identity of the lender and the defined name information that is stored in the database of information.

15. A system for processing electronic loan documents, comprising:
an electronic document server including:
electronic loan document manager access rules;
electronic loan document processor access rules;
electronic loan document originator access rules; and
electronic loan document recipient access rules;
an originator interface for receiving an electronic loan document by the electronic document server from an originator in accordance with the electronic loan document originator access rules;
a processor interface for processing the electronic loan document by a processor in accordance with the electronic loan document processor access rules;
a manager interface for managing the electronic loan documents in accordance with the electronic loan document manager access rules;
a recipient interface for transmitting the electronic loan document by the electronic document server to a recipient in accordance with the electronic loan document recipient access rules; and
a superuser interface for defining the electronic loan document originator access rules, the electronic loan document processor access rules, the electronic loan document manager access rules, and the electronic loan document recipient access rules.

16. A method for processing electronic documents, comprising:
providing an electronic document server including:
electronic document originator access rules; and
electronic document recipient access rules;
providing an originator interface;
providing a recipient interface;
receiving an electronic document by the electronic document server from an originator using the originator interface in accordance with the electronic document originator access rules; and
transmitting the electronic document by the electronic document server to a recipient using the recipient interface in accordance with the electronic document recipient access rules.

17. The method of claim 16, wherein the electronic document originator access rules prevent the originator from modifying the electronic document received by the document server from the originator.

18. The method of claim 16, wherein the electronic document originator access rules prevent the originator from viewing a second electronic document received by the document server from a second originator.

19. The method of claim 18, wherein the recipient access rules allow a recipient to view the electronic document and the second electronic document.

20. The method of claim 16, wherein the document server further includes electronic document processor access rules, the method further comprising:
providing a processor interface; and
processing the electronic document by a processor using the processor interface in accordance with the electronic document processor access rules.

21. The method of claim 20, wherein the document server further includes electronic document manager access rules, the method further comprising:
providing a manager interface; and
managing the electronic documents by a manager using the manager interface in accordance with the electronic document manager access rules.

22. The method of claim 16, wherein the electronic document server further includes an expandable electronic file for storage of electronic documents.

23. The method of claim 22, wherein the electronic document recipient access rules include a stacking order for organizing electronic documents stored in the expandable electronic file and transmitted to the recipient.

24. The method of claim 16, further comprising:
providing a scanner for generating scanned electronic documents; and
transmitting the scanned electronic documents to the electronic document server via the originator interface.

25. The method of claim 24, wherein the originator interface further includes an interface for identifying a name and a document type for the scanned document.

26. The method of claim 16, further comprising:
providing a superuser interface for defining the electronic document originator access rules and the electronic document recipient access rules.

27. A method for processing electronic loan documents, comprising:
providing an electronic document server including:
electronic loan document manager access rules;
electronic loan document processor access rules;
electronic loan document originator access rules; and
electronic loan document recipient access rules;
providing an originator interface;
providing a processor interface;
providing a recipient interface;
receiving an electronic loan document by the electronic document server from an originator using the originator interface in accordance with the electronic loan document originator access rules;
processing the electronic loan document by a processor using the process interface in accordance with the electronic loan document processor access rules; and
transmitting the electronic loan document by the electronic document server to a recipient using the recipient interface in accordance with the electronic loan document recipient access rules.

28. The method of claim 27, further comprising:
providing a manager interface; and
managing the processing of the electronic loan documents by a manager using the manager interface in accordance with the electronic loan document manager access rules.

29. The method of claim 27, further comprising:
providing a superuser interface; and
defining the electronic loan document originator access rules, the electronic loan document processor access rules, the electronic loan document manager access rules, and the electronic loan document recipient access rules by a superuser using the superuser interface.
